(19) United States
(12) Patent Application Publication
(10) Pub. No.: US 2026/0070569 A1
(43) Pub. Date: Mar. 12, 2026

(54) SELECTIVE TRAINING DATA DENSIFICATION FOR MACHINE LEARNING OF SAFETY-CRITICAL AUTONOMY

(71) Applicant: The Regents of the University of Michigan, Ann Arbor, MI (US)

(72) Inventors: Henry Liu, Ann Arbor, MI (US); Haojie Zhu, Ann Arbor, MI (US); Haowei Leandra Sun, Ypsilanti, MI (US); Xintao Yan, Ann Arbor, MI (US); Boqi Li, Ann Arbor, MI (US); Shengyin Shen, Ann Arbor, MI (US)

(21) Appl. No.: 19/326,702

(22) Filed: Sep. 11, 2025

Related U.S. Application Data
(60) Provisional application No. 63/693,585, filed on Sep. 11, 2024.

(51) Int. Cl. B60W 50/00; B60W 60/00

(52) U.S. Cl. CPC B60W 50/0098; B60W 2050/0031; B60W 60/0015; B60W 2556/05

(57) ABSTRACT

A system and method of training a safety-critical autonomous agent. The method carried out by the system includes: obtaining initial training data to be used for training a safety-critical autonomous agent; densifying the initial training data using a data densification process in order to generate densified training data; and training a safety-critical autonomous agent using the densified training data. The data densification process includes: selecting safety-critical episodes from the initial training data in order to generate safety-critical episode training data; and/or generating artificial safety-critical episode data representing one or more artificial safety-critical episodes, wherein the artificial safety-critical episode data is generated based on at least one safety-critical episode. The densified training data is or is based on one or both of the safety-critical episode training data and the artificial safety-critical episode data.

### STATEMENT REGARDING FEDERALLY SPONSORED RESEARCH/DEVELOPMENT

This invention was made with government support under 2223517 awarded by the National Science Foundation and under 69A3551747105 awarded by the U.S. Department of Transportation. The government has certain rights in the invention.

### TECHNICAL FIELD

This disclosure relates to preparation of training data to be used for training a safety-critical autonomous agent, such as, for example, a safety-critical driving agent for an autonomous vehicle (AV).

### BACKGROUND

Autonomy of robots, vehicles, electromechanical devices, and other electronically-controlled automatons are more and more prevalent with the continuous development of semiconductor technology and machine learning (ML). Indeed, the dream of autonomous vehicles (AVs) has been around for approximately a century. Over the past two decades, there has been remarkable progress in AV development, largely driven by advancements in artificial intelligence (AI) technology. Through the utilization of extensive data and training deep neural networks, AVs have made significant strides in terms of safety performance, particularly in normal driving situations. The disengagement rate, as reported in California Department of Motor Vehicle reports, has improved from 10-3 disengagements per mile in 2015 to 10-5 disengagements per mile in 2022. However, before AVs can be deployed on a large-scale, their safety performances still need to be improved by one to two orders of magnitude. This is because the crash probability for the average human driver in the United States is approximately 1.9×10-6 per mile, and AVs are expected to be significantly safer than human drivers. Unfortunately, existing approaches have encountered a major bottleneck, resulting in a significant slowdown and even stagnation in the improvement of AV's safety performance in recent years. This raises concerns that AVs may not be capable of handling rare but safety-critical driving scenarios, despite millions of testing miles that have been accumulated on public roads. Enhancing the safety performance of AVs by a factor of ten to a hundred with two distinct initial benchmarks (10-3 crashes per mile vs. 10-5 crashes per mile) presents entirely different challenges, as the latter has much lower frequency of safety-critical events, which demands much higher amount of training data. This calls for a fundamental change in problem formulation and solution approaches.

Such safety challenge for AVs is referred to as the “Curse of Rarity” (CoR), which arises due to the rarity of safety-critical events in high-dimensional variable spaces. It has, thus, been recognized that this is a compounding effect resulting from the rarity of events combined with the high dimensionality of related variables. As the utilization of deep learning techniques is typically necessary to address the high dimensionality, the rarity of events dramatically increases the estimation variance of policy gradient, thereby impeding the ability of deep-learning models to learn. Furthermore, during the AV training process, better AV safety performance also means fewer safety-critical events, which, in turn, makes it even more difficult to improve the safety performance. These issues pose significant obstacles to the development of AI-based agents who aim to minimize the occurrence probability of rare events, which are essential for training AVs to ensure safety performance. It should be emphasized that previous advancements in AI have primarily been focused on non-safety-critical applications such as chatbots and games, where a certain level of failure is deemed acceptable. However, when it comes to safety-critical autonomous systems, such as AVs, an extremely high level of safety performance is demanded, resulting in the CoR challenge.

Existing approaches attempted to tackle the CoR challenge primarily focus on learning from the data where AI systems exhibit failures. For instance, Tesla™ had reported training their systems on datasets that represent scenarios where AVs struggle or deviate from human driver behavior. However, it is important to note that these approaches lack a solid theoretical foundation; it has hereby been discovered via investigations that such approaches can exhibit significant biases and even be misleading. Consequently, while these approaches may enhance the safety performance of AVs in specific scenarios, they run the risk of compromising performance in other safety-critical situations. This phenomenon, known as the “seesaw effect” in different domains [Stocker, T. F., 1998. The seesaw effect. Science, 282 (5386), pp. 61-62], hinders the improvement of overall safety performance and leads to performance stagnation. That is also a key reason why safety-critical driving situations are seemingly endless, despite years of development in AVs. Alternatively, some researchers have attempted to prevent unsafe behaviors of AVs based on rules or models such as formal methods and constrained. Nonetheless, this approach faces challenges to handle the variability and complexity in high-dimensional variable spaces, because it is difficult to rely on a predefined set of parameters and assumptions for a wide spectrum of diverse driving situations.

### SUMMARY

In accordance with an aspect of the invention, there is provided a method of training a safety-critical autonomous agent, wherein the method comprises:
obtaining initial training data to be used for training a safety-critical autonomous agent;
densifying the initial training data using a data densification process in order to generate densified training data, wherein the data densification process includes:
   selecting safety-critical episodes from the initial training data in order to generate safety-critical episode training data; and/or
   generating artificial safety-critical episode data representing one or more artificial safety-critical episodes, wherein the artificial safety-critical episode data is generated based on at least one safety-critical episode;
wherein the densified training data is or is based on one or both of the safety-critical episode training data and the artificial safety-critical episode data; and
training a safety-critical autonomous agent using the densified training data.

Various embodiments of the method may include any of the following additional features, either alone or in any technically feasible combination.
the data densification process further includes: modifying one or more states of one or more safety-critical episodes in order to remove non-informative states.
the data densification process includes selecting safety-critical episodes from the initial training data in order to generate the safety-critical episode training data, and wherein the one or more safety-critical episodes modified to remove the non-informative states includes at least one of the selected safety-critical episodes.
the data densification process includes:
   selecting the safety-critical episodes from the initial training data;
   modifying one or more states of one or more of the selected safety-critical episodes in order to remove non-informative states; and
   generating the artificial safety-critical episode data representing one or more artificial safety-critical episodes, wherein the artificial safety-critical episode data is generated based on at least one safety-critical episode.
the artificial safety-critical episode data is generated as a result of a counterfactual simulation performed using output data of the safety-critical autonomous agent that was generated based on the at least one safety-critical episode.
the at least one safety-critical episode is or includes one or more of the selected safety-critical episodes.

In accordance with another aspect of the invention, there is provided a system for carrying out the above method. The system comprises at least one processor and computer-readable memory accessible by the at least one processor, the memory storing software comprising computer instructions that, when executed by the at least one processor, configures the at least one processor to carry out the method.

Various embodiments of the system may include computer instructions for carrying out any of the additional features of the method noted above, either alone or in any technically feasible combination.

In accordance with another aspect of the invention, there is provided a method of training a safety-critical autonomous agent, wherein the method comprises:
obtaining initial training data that comprises data from both avoidable crash episodes and episodes where crashes were successfully avoided;
generating edited training data from the initial training data using Markov chain editing, wherein the edited training data has an increased proportion of safety-critical states than that contained in the initial training data;
providing an AV policy for use with the edited training data;
generating densified training data by reclassifying data for the AV policy through counterfactual simulation; and
training a safety-critical autonomous agent using the densified training data.

In some embodiments of the method of the immediately-preceding paragraphs, the generating of edited training data may further comprise obtaining a Markov chain of sampled driving episodes from the initial training data and editing the Markov chain sampled driving episodes so that only safety-critical states are retained and reconnected in the edited training data. Further, in some embodiments, the editing of the Markov chain sampled driving episodes may comprise editing the Markov chain using a dense deep reinforcement learning densification process.

### BRIEF DESCRIPTION OF THE DRAWINGS

Illustrative embodiments will hereinafter be described in conjunction with the appended drawings, wherein:

FIG. 1 is a diagram depicting a dense learning-based autonomous training system that is used for training a safety-critical autonomous agent such as an autonomous driving agent;

FIG. 2 is a diagrammatic representation of a high-dimensional sequential decision-making space, which is used for defining an AV policy;

FIG. 3 is a diagrammatic representation of three types of data that may be used for learning;

FIG. 4 shows an example of a multi-lane highway driving task for a host AV;

FIGS. 5 and 6 show training of the AV policy using all data and only crash data, respectively;

FIGS. 7 and 8 depict the results of training with all data and only crash data, respectively;

FIG. 9 depicts the comparison of AV policy before and after one particular training step;

FIG. 10 depicts training of an AI-based safety metric by identifying and densifying critical data;

FIGS. 11-13 together depict a performance evaluation of a dense learning approach in simulations;

FIG. 14 diagrammatically shows an operating environment for an AV;

FIG. 15 depicts an illustration of a real AV under test that is equipped with various sensors and processing devices;

FIG. 16 is a flowchart of a method of training a safety-critical autonomous agent;

FIG. 17 shows a training pipeline of the safety-critical driving agent for a real AV;

FIG. 18 is an illustration of a mixed-reality environment combining simulated background vehicles with physical road infrastructure, proxy objects, and simulation;

FIGS. 19A-B show a framework of an actual mixed reality testing environment;

FIG. 20 depicts a graph showing acceleration over time for real vehicles and at command of the safety-critical driving autonomous agent;

FIG. 21 depicts a graph of crash rates for a base AV model and various models described herein; and

FIG. 22 shows a graph of avoidable crash rates for the base AV model compared to those resulting from use of a model trained in accordance with the approach described herein.

### DETAILED DESCRIPTION

The system and method described herein enables dense learning for machine learning (ML), such as a neural network, particularly through episodic data densification whereby informative driving episodes are selected, Markov chain editing in order to retain only (or at least a higher proportion of) safety-critical states, and retrospective data densification in order to select informative driving episodes as a result of a counterfactual simulation. Such techniques, particularly when used in combination with one another, provide for a dense learning framework that densifies training data, namely autonomous vehicle (AV) training data, through sampling data in proportion to its contributions to policy gradient and exposure frequency. This densified training data is then used for training a safety-critical autonomous agent, which may be a safety-critical driving agent in the case of AVs. It will be appreciated that the “safety-critical driving agent” referred to herein is an example of a “safety-critical autonomous agent,” and the discussion of the safety-critical driving agent is hereby attributed to the safety-critical autonomous agent.

Three data densification techniques are used for densifying the data prior to training the safety-critical autonomous agent, and these techniques are implemented as a part of the system using three densification components, including: (1) a safety-critical episode selection component (also referred to herein as a “first densification component”); (2) an episode state modification component (also referred to herein as a “second densification component”); and (3) a retrospective counterfactual simulation component (also referred to herein as a “third densification component”). As discussed more below, the training data is densified through sampling data based on its contribution to policy gradient and exposure frequency. In the context of reinforcement learning, a policy gradient refers to a method for optimizing the decisions made by an algorithm. Specifically, it is a technique used to train a neural network (which implements the “policy”) that makes decisions, such as controlling the maneuvers of vehicles in an autonomous driving scenario. The policy gradient method works by evaluating the performance of the policy and then adjusting the neural network's parameters in a direction that increases the likelihood of successful outcomes. Accordingly, here, policy gradient refers to optimizing parameters of a neural network (representing a policy) that is used to generate an output, which may be used for making decisions of an autonomous system or device. For example, in the case of autonomous vehicles, this could mean adjusting the network to make decisions that lead to a target outcome, such as safer driving and fewer accidents. The target outcome may be defined by a reward function. A dense deep reinforcement learning (D2RL) approach estimates the policy gradient by using the data from critical states, which are the states most relevant to safety, and discards the data from uncritical states, which do not contribute to learning safety-critical events. By focusing on these critical states, the D2RL approach can reduce the variance of the policy gradient estimation, which enables more effective learning and better decision-making by the neural network policy. This is particularly important in the context of autonomous driving, where the safety-critical events are rare but have significant consequences. Exposure frequency refers to how often certain scenarios, such as driving scenarios, occur naturally within the data (the initial training data), which may be representative of how often certain driving scenarios occur naturally on the road. This can be quite important for training AVs to handle common situations they will encounter while driving.

As discussed above, in embodiments, a D2RL approach is used for densifying driving state data from each driving episode, and such a D2RL approach may be adapted from the one set forth in U.S. Patent Application Publication No. 2023/0358640 A1, published Nov. 9, 2023 and corresponding to U.S. patent application Ser. No. 18/143,475, the entire contents of which are hereby incorporated and attributed to the present system to the extent not inconsistent with the express description herein.

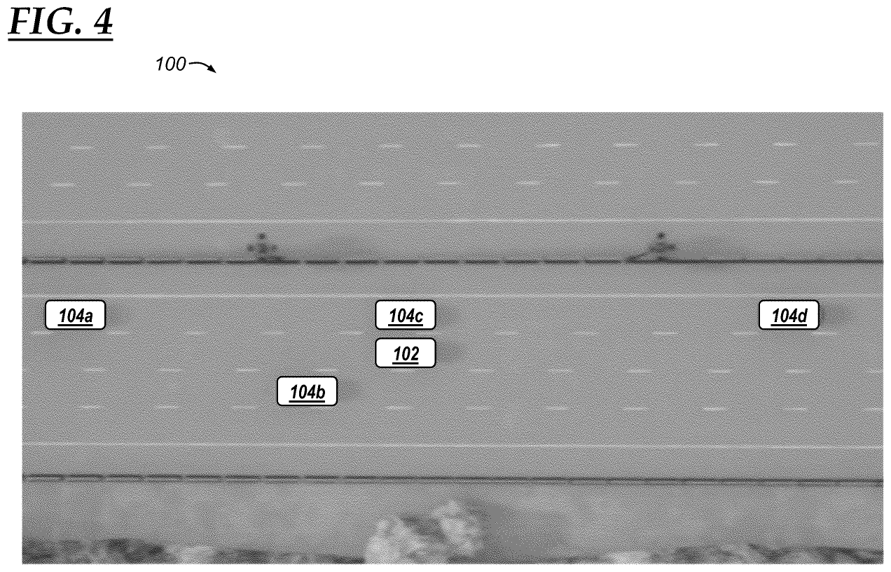

The system and method below, at least according to some embodiments, addresses the curse of rarity (CoR) challenge by densifying training data so that the training process overcomes performance stagnation, allowing AVs to continually improve their safety performance beyond the current state-of-the-art. Such an approach provides a pathway for AVs to achieve and surpass human driving safety performance, at least in certain embodiments or implementations. Based on importance sampling theory, it was hereby discovered that optimal data distribution for training neural networks to overcome CoR should be based on their contribution to the policy gradient and their exposure frequency, as proved in Theorem 1 below. Theorem 1 ensures the unbiasedness of AV training and effectively overcomes the “seesaw effect.” However, because the AV policy gradient for each driving episode of training data cannot be calculated practically, the magnitude of policy gradient is approximated as either 1 or 0 (one of a set of discrete values, here one of two possible values), depending on whether the data contains useful information. After sampling episodes of data according to their exposure frequencies, only informative data, which include both successful and failed safety-critical events, is retained in the training set, while non-informative data is rejected. With the densified training data, such a dense learning approach dramatically reduces the variance for rare event learning without loss of unbiasedness (FIG. 3), as indicated in Theorem 2 below.

Specifically for AV safety training, for example, the training data set desirably includes data from both avoidable crash episodes and episodes where crashes were successfully avoided (near-misses). This differs significantly from existing approaches that learn from failures (crash data episodes) only. The proposed dense learning approach (also referred to as the “proposed approach”) suggests that learning from successes—those safety-critical events where crashes are avoided successfully—could be even more important than learning from failures, as the exposure frequencies of successes are usually higher than those of failures, and this is represented by the first densification component. Additionally, as each driving episode can span many time steps, the Markov chain of each sampled episode was further edited where only safety-critical states are retained and reconnected [Feng, S., Sun, H., Yan, X., Zhu, H., Zou, Z., Shen, S. and Liu, H. X., 2023. Dense reinforcement learning for safety validation of autonomous vehicles. Nature, 615 (7953), pp. 620-627]. In embodiments, such editing of the Markov chain is implemented using the D2RL densification approach of U.S. Patent Application Publication No. 2023/0358640 A1, which is hereby incorporated and attributed to the second densification component set forth herein. This can further densify training data within each driving episode. Lastly, due to the changing AV policy during training, achieving both higher precision and recall rates for identifying informative episodes and critical states has become difficult. To address this an AI-based safety metric is proposed, and being designed to serve as a real-time predictive evaluation tool. The third densification component is a retrospective evaluation component to reclassify all data for the new AV policy through counterfactual simulation. An exemplary embodiment of the overall dense learning approach is shown in the FIGS. and described below.

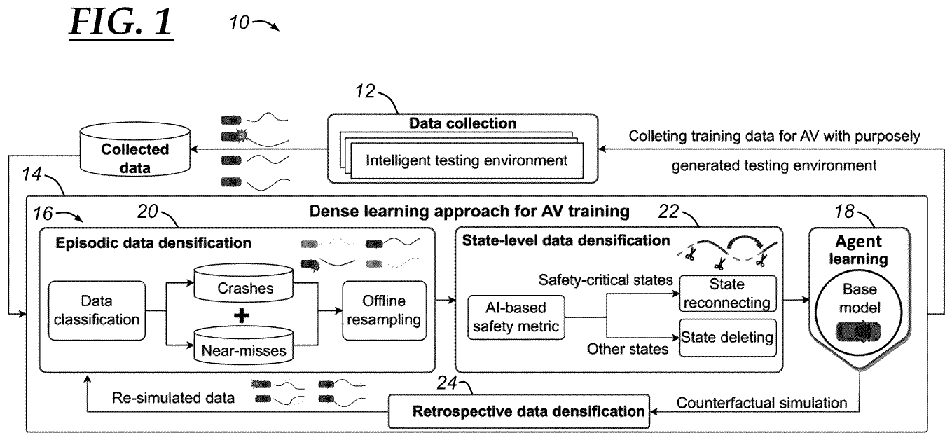

With reference to FIG. 1, there is shown a dense learning-based autonomous training system 10 that is used for training a safety-critical autonomous agent and, in the exemplary embodiment discussed below, is a dense learning-based AV training system 10 that is used for training a safety-critical driving agent. The dense learning-based autonomous training system 10 is comprised of hardware, namely at least one processor and memory, as well as software or other computer code or instructions (referred to herein as “computer instructions”) that is executed by the hardware. Accordingly, computer instructions are stored in the memory of the dense learning-based autonomous training system 10, and these computer instructions are made available to the at least one processor of the dense learning-based autonomous training system 10, which then executes the computer instructions so as to perform a method of densifying data for training a safety-critical autonomous agent, as discussed more below.

The at least one processor of the dense learning-based AV training system 10 refers to one or more electronic processors. Any one or more of these processors or other processors discussed herein may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc.

The memory of the dense learning-based AV training system 10 refers to one or more non-transitory, computer-readable memory devices (or memories), and any of these memories or other memory discussed herein may be implemented as any suitable type of memory that is capable of storing data or information in a non-volatile manner and in an electronic form so that the stored data or information is consumable by the processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid state hybrid drives (SSHDs)), other types of flash memory, hard disk drives (HDDs), non-volatile random access memory (NVRAM), etc. It will be appreciated that the computers may include other memory, such as volatile RAM that is used by the processor, and/or multiple processors.

The memory serves as a local data store for storing the computer instructions, but may also be used for storing various data obtained or generated by the dense learning-based autonomous training system 10. A “data store” or “electronic data store” refers to any data storage platform, such as cloud storage services like Amazon S3™ or Google Drive™, relational databases like MySQL™ or PostgreSQL™, and NoSQL databases like MongoDB™ or Cassandra™, that is designed for storing data in a manner accessible by electronic processing systems. This includes any repository that allows for the organization, management, and retrieval of data through digital means, enabling efficient data handling, analysis, and processing by computers and other electronic devices. This electronic data store could take the form of a cloud database, such as Amazon's DynamoDB™, which offers seamless scalability and performance. Alternatively, for structured data and frequent queries, a relational database like MySQL™ or PostgreSQL™ could be employed. If the data is unstructured or semi-structured and comes in large volumes, NoSQL databases such as MongoDB™ or Apache Cassandra™ might be more suitable. For data that is time-series in nature, time-series databases like InfluxDB™ or TimescaleDB™ could provide efficient storage and query capabilities. For large-scale data analysis, data warehousing solutions such as Google BigQuery™, Amazon Redshift™, or Snowflake™ can be used. In cases where fast data access is paramount, in-memory databases like Redis™ or Memcached™ could be employed. Lastly, for storing large volumes of raw data, distributed file systems like Hadoop HDFS™ or cloud-based solutions like Amazon S3™ could be used. The choice of data store would ultimately depend on the specific requirements of the system handling the data. The dense learning-based autonomous training system 10 may be implemented using a variety of different processing techniques, including use of cloud computing frameworks and services, such as those offering real-time data streaming and processing, such as Amazon Web Services (AWS) Kinesis™, for example. In other embodiments, local computers or processing machines may be used for the hardware.

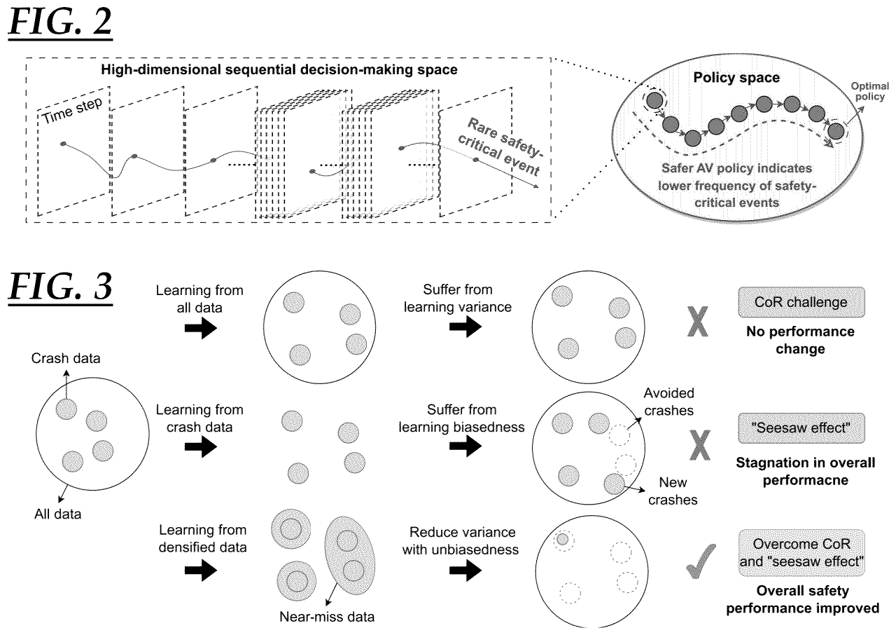

With reference to FIG. 2, there is shown a diagrammatic representation of a high-dimensional sequential decision-making space, which is used for defining a policy that, as shown, is adjusted as a result of learning in order to determine an optimal policy. Oftentimes, a quintessential AV training goal is to minimize the probabilities of safety-critical rare events and related quantities in a high-dimensional space, which suffers from the CoR challenge. Moreover, better AV safety performance means fewer safety-critical events, which, in turn, makes it even more difficult to improve the safety performance.

With reference to FIG. 3, there is shown a diagrammatic representation of three types of data that may be used for learning, including all data (top), crash data (middle), or densified data (bottom). Learning from all data suffers from severe variance due to the CoR challenge and cannot learn an effective policy. Existing approaches attempted to tackle the CoR challenge primarily focus on learning from the data where AI systems exhibit failures (such as crash event data), which could mislead the training process, causing the “seesaw effect”. The proposed approach overcomes the “seesaw effect” by training AVs with densified data, where both informative failure events and informative success events (near-misses) are included, improving AVs' overall safety performances.

With reference back to FIG. 1, the dense learning-based AV training system 10 is shown as having a training data collector 12 and a learning module 14. The training data collector 12 is used to collect AV data from a testing environment and to then provide that obtained data to the learning module 14 for learning. The learning module 14 includes a data densification pipeline 16 and a training module 18, which are used together for preparing training data and then training an ML model on the training data. The data densification pipeline 16 includes three data densification modules 20, 22, 24, each of which densify input training data in a different manner. In some embodiments the data densification pipeline 16 includes less than three data densification modules such as, for example one or more of the data densification modules 20, 22, 24. This three-layered densification learning framework dramatically reduces learning variance for rare event learning without loss of unbiasedness, at least in embodiments.

The first data densification module 20 is illustrated in the depicted embodiment as an episodic data densification module that is configured to selectively densify input training data through selecting informative driving episodes. The episodic data densification module 20 includes a data classifier that classifies whether the training data is a part of a vehicle crash/collision or a near miss, which means here in a near miss of a vehicle crash/collision. After the data is classified as such, selective resampling is performed on the classified data so as to select informative driving episodes.

The second data densification module 22 is illustrated in the depicted embodiment as a state level densification module that is configured to modify data of an episode in order to densify salient and or otherwise informative information within the episode while removing non salient or non-informative information from the episode. The state level data densification module 22 includes an artificial intelligence based safety metric that is used for identifying safety critical states of a driving episode. Then, the episode data is edited to remove non safety critical states such as that which is taught as a part of the D2RL feature discussed herein. In one embodiment, the state level densification module densifies the data by editing AV's decision-making Markov chain to retain only safety-critical states.

The third data densification module 24 is illustrated in the depicted as a retrospective data dentification module that is configured to modify portions an episode used previously for training, such as by re-simulating portions of the episode in order to densify salient and or otherwise informative portions of the episode. This re-simulation based densification process involves re-selection of informative driving episodes through counterfactual simulation.

Specifically for AV safety training, it has been realized that the training data set preferably includes data from both avoidable crash episodes and episodes where crashes were successfully avoided, also referred to as near-misses. Existing approaches learn from failures (crash data episodes) only. The proposed dense learning approach suggests that learning from successes—those safety-critical events where crashes are avoided successfully—could be even more important than learning from failures, as the exposure frequencies of successes are usually higher than those of failures. Additionally, as each driving episode can span many time steps, the Markov chain of each sampled episode may be edited, where only safety-critical states are retained and reconnected through use of the state level densification module 22. This can further densify training data within each driving episode. Lastly, due to the changing AV policy during training, achieving both higher precision and recall rates for identifying informative episodes and critical states has become difficult. To address this, an AI-based safety metric is used to serve as a real-time predictive evaluation tool. It also includes a retrospective evaluation component, embodied by the retrospective data densification module 24, to reclassify all data for the new AV policy through counterfactual simulation.

In the case of AVs, intuitively, the events where an AV system fails may contain valuable information for further training. However, a concerning issue with learning from failures was discovered. While it may initially be effective during AV training compared to learning from all data, it can eventually lead to biased and misleading outcomes, resulting in the “seesaw effect” and compromising the overall safety performance. To demonstrate this, an experiment was conducted where a base AV model was trained using proximal policy optimization (PPO) for a multi-lane highway driving task, as discussed below.

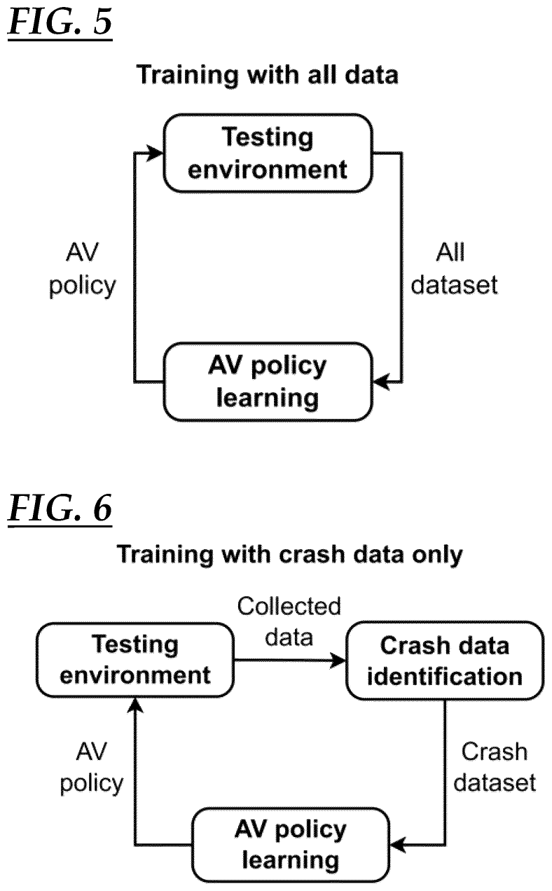

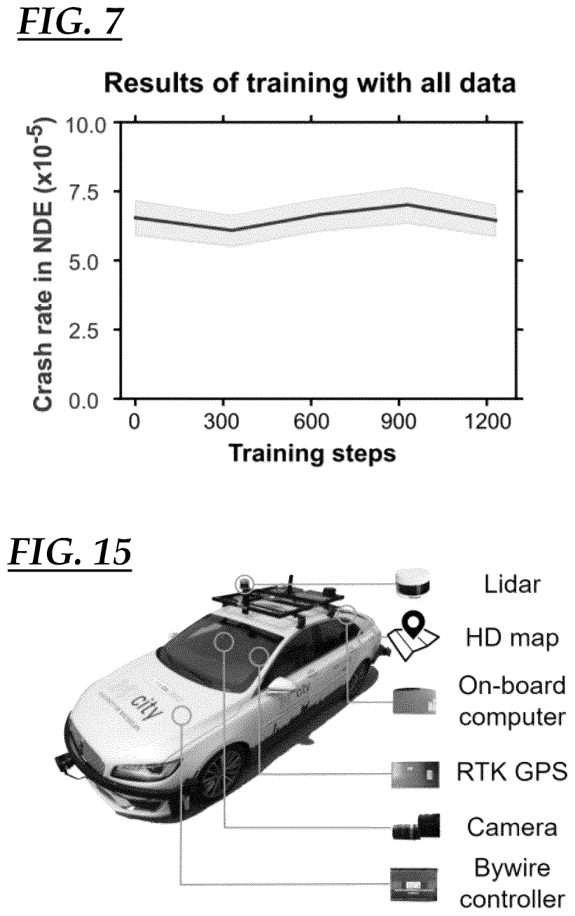

With reference now to FIGS. 4-9, there are shown results of learning-from-all data and learning-from-crash-only data. FIG. 4 shows an example 100 of a multi-lane highway driving task, where a host AV 102 is to drive for a 400 meter (m) distance interacting with surrounding background vehicles 104a,b,c,d. Then, the AV policy was also trained using all data (FIG. 5) and only the crash data (FIG. 6), respectively. The behaviors of background vehicles in a naturalist driving environment (NDE) were generated based on naturalistic driving data, so the crash rate of AVs in NDE can represent the safety performance of AVs in the real world. Specifically, the large-scale naturalistic driving data from the Safety Pilot Model Deployment (SPMD) program and the Integrated Vehicle Based Safety System (IVBSS) at the University of Michigan, Ann Arbor was used.

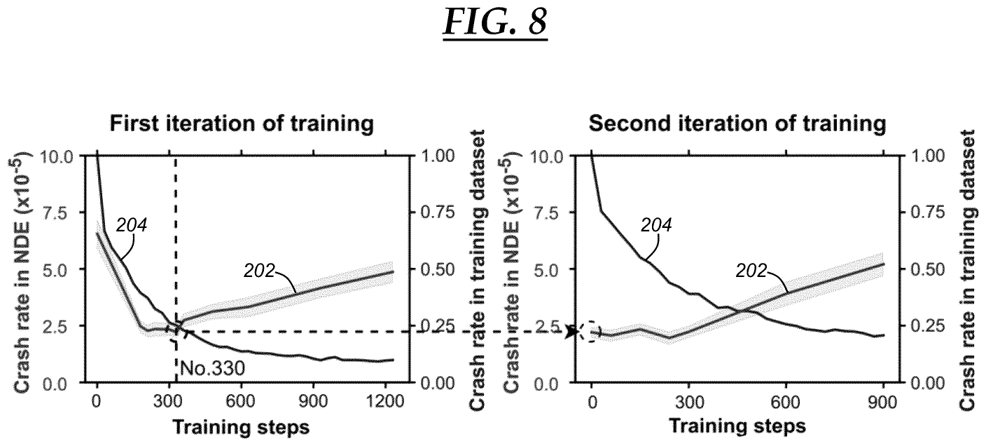

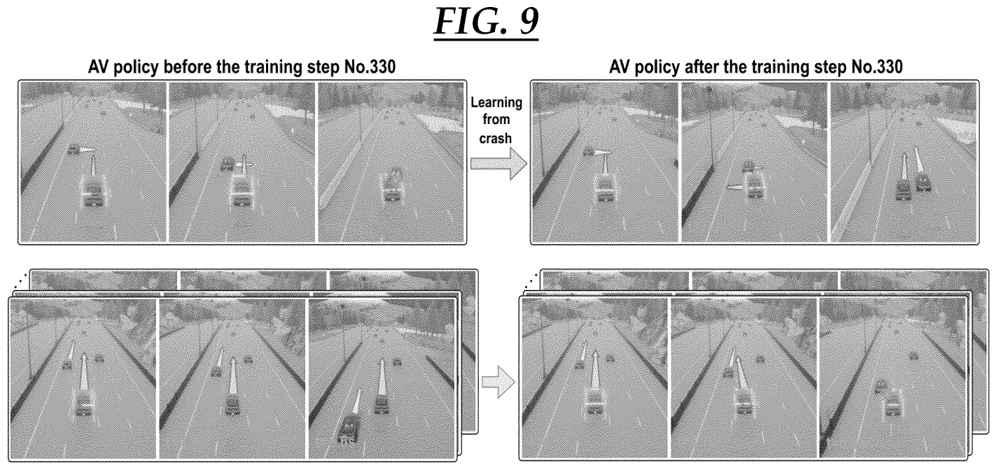

Compared with learning from all data, which suffers from the CoR with no performance improvement (FIG. 7), learning solely from crash data initially decreased the crash rate of the AV in NDE (FIG. 8, lines 202). The shaded area represents the 90% confidence level and the solid lines represent the average, for both FIGS. 7 and 8. No safety performance was observed from training with all data. However, after reaching a certain number of training steps (e.g., training Step No. 330 in the depicted embodiment), the training process became misguided, resulting in an increase in the crash rate in NDE, despite the continuing decrease in the crash rate in the training dataset (FIG. 8, lines 204). To address this issue, crash events specific to the AV policy at training step No. 330 were collected and the policy was further trained using these newly collected crash events. This approach yielded similar results (as shown in the right side of FIG. 8). It was also demonstrated the existence of a “seesaw effect” by revealing that although the AV learned to perform evasive lane changes to avoid crashes caused by reckless cut-in behaviors of other vehicles, these evasive lane changing behaviors sometimes became too aggressive, leading to even more crashes (as illustrated in FIG. 9). Such phenomenon highlights a significant factor contributing to the stagnation in the safety performance of state-of-the-art AVs. As AV technology has advanced beyond its initial stages, addressing such an issue contributes to ensuring continued progress in enhancing AV safety.

In essence, the “seesaw effect” is caused by the biasedness of learning from crash data only, while learning from all data suffers from severe variance owing to the CoR (see discussion of Methods below). To address the CoR and prevent the “seesaw effect,” an innovative dense learning approach for AV training was developed. The key to dense learning is to remove the non-informative data, thereby reducing the learning variance while maintaining the learning unbiasedness. Removing a larger amount of non-informative data leads to a greater reduction in variance. However, accurately defining, identifying, and effectively utilizing informative data for AV training pose significant challenges.

To address this challenge, the optimal training data distribution for AV training is derived based on importance sampling theory (see Theorem 1 in Methods) as

$${q}_{π}^{*} ( X ) ∝ {‖ {∇}_{π} P ( {A}_{π} \vert X ) ‖}_{2} \times P ( X ) \qquad Equation ( A )$$

where X denotes each driving episode of the training data, π denotes the AV policy, A denotes events of interest (for example, crash events), ∇_{π}P(A_{π}|X) is the policy gradient for the probability of A given X, ∥⋅∥₂ denotes the l2 norm of the vector, P(X) denotes the exposure frequency of X in NDE,

$${q}_{π}^{*} ( X )$$

denotes the optimal probability distribution of X for training the policy π, and the symbol ∝ means ‘proportional to’. Here, an episode is a segment of recorded driving data with a predetermined time duration or distance. It indicates that the optimal training data should contain both avoidable crash events (informative failures) and near-miss events (informative successes) where ∥∇_{π}P(A_{π}|X)∥₂ is non-zero, while the data of those unavoidable crash events and safe situations should be removed. As the exposure frequencies of near-miss events are usually higher than those of failures, learning from near-miss events is more important than learning from crashes, which is counterintuitive

The primary obstacle in applying Equation (A) is that ∥∇_{π}P(A_{π}|X)∥₂ for each driving episode of data cannot be calculated practically, exacerbated by the changing AV policy during the training process. Equation (A) can be utilized as a guidance for data densification. Therefore, rather than attempting to compute the precise values of ∥∇_{π}P(A_{π}|X)∥₂, an approximation through a binary classification task is adopted. In this task, ∥∇_{π}P(A_{π}|X)∥₂ is approximated as one for informative data, that is, avoidable crash events and near-miss events. Specifically, a crash event is identified as avoidable if an evasive trajectory is feasible within the safety-critical states and a non-crash event as a near-miss if the minimum relative distance between the AV 102 and background vehicles 1014a,b,c,d is below a pre-determined threshold. Although these criteria are not unique, these simple yet effective ones are chosen to demonstrate the effectiveness of the proposed approach. By sampling the episodes according to P(X) and rejecting these where ∥∇_{π}P(A_{π}|X)∥₂ is estimated as zero, this proposed approach realizes the training data distribution as in Equation (A), dramatically reducing variance for rare event learning without compromising unbiasedness, as indicated in Theorem 2 in Methods.

Theorem 2 also ensures the adaptability of the proposed approach to leverage existing state-level data densification techniques. As each driving episode may last for many time steps, the Markov chain of each sampled episode was further edited, where only safety-critical states are retained and reconnected. This is challenging in AV training, as different AV policies during the training process could have different safety-critical states and so identifying them with both high precision and recall rates is desirable.

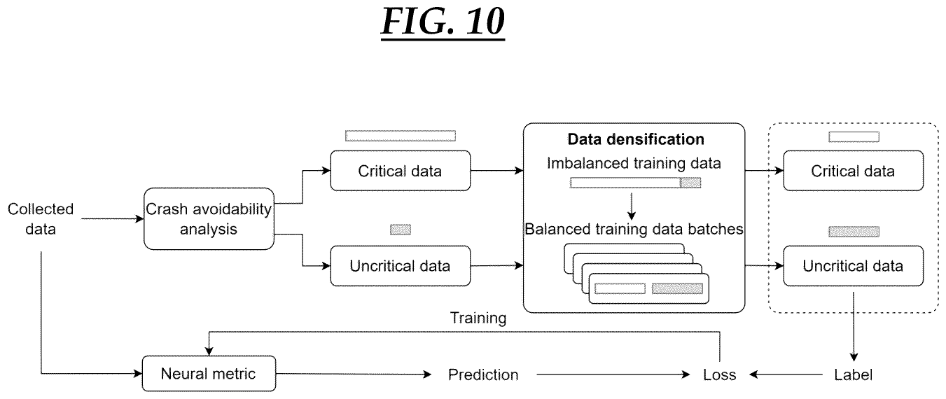

To address this challenge, and with reference to FIG. 10, an AI-based safety metric, which obtains the highest area under the curve (AUC), the highest precision at high recall, and the smallest computational time, is compared with existing approaches including Safety Metric based on the Assessment of Risk (SMAR), Model Predictive Instantaneous Safety Metric (MPrISM), Pegasus Criticality Measure (PCM), and time-to-collision (TTC). Computational efficiency is particularly critical for the real-time application of the safety metric. FIG. 10 depicts training of the AI-based safety metric and, more particularly, illustrates identifying and densifying the critical data to address the data imbalance issue, which can be severe in certain applications. Instead of rebalancing the data before training, which could introduce biasedness, positive and negative snapshots were resampled from all the data to create balanced training data batches in each training step. In this way, the training data in each training step is rebalanced, while the unbiasedness for the overall training process is retained.

Moreover, as AV policy is changed after training, a large policy gap may exist between the new AV policy and the policy that collected the data. To bridge this gap, a retrospective evaluation component is introduced to reidentify the informative episodes and critical states for the new AV policy through counterfactual simulation. Furthermore, to improve the efficiency of data collection, the intelligent testing environment (ITE) of U.S. Patent Application Publication No. 2023/0358640 A1, particularly the testing environment shown and described therein for testing a dense deep reinforcement learning (D2RL) agent, which is hereby incorporated and attributed to the present embodiment. The data collected by the ITE contain considerably more crash events and near-misses than those from NDE. Each of the crash and near-miss event has a likelihood weight. By the offline resampling mechanism, the resampled data has the unbiased distribution of the safety-critical events, compared with the NDE data. Therefore, the ITE can dramatically accelerate the data collection process for AV training while maintaining unbiasedness. As the data collection is arguably the most time-consuming and cost-expensive step for AV training, this approach dramatically accelerates the overall training process. Utilizing ITE allows acceleration of the collection of informative training data by multiple orders of magnitude without loss of unbiasedness. Given that data collection is often the most time-consuming and costly step in AV training, this approach dramatically accelerates the overall training process.

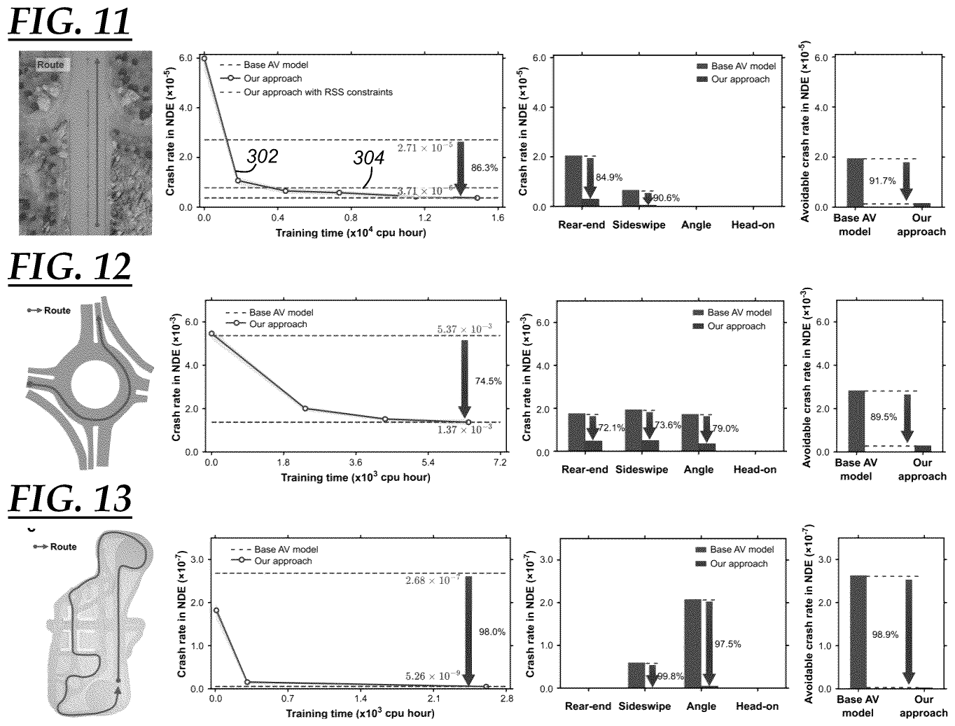

The effectiveness of the approach according to the present exemplary embodiment was evaluated by systematic simulation analysis. To measure the overall safety performances of AVs for quantitative comparisons, the crash rate per test of AVs in NDE were utilized. As NDE is generated based on naturalistic driving data, testing results in NDE can represent the safety performance of AVs in the real world. Specifically, different types of base AV models were selected, and a safety-critical driving agent that only takes over base AV models in safety-critical states (identified by the AI-based safety metric) was trained, resulting in the integrated AV models. Then, the safety performances of base AV models and integrated AV models in NDE were compared. Although the baseline models are referred to as “base” AV models, such models could be advanced commercial AV models with large-scale neural networks together with their own safety guards, for example. To demonstrate the generalizability and applicability of the proposed approach, experiments were conducted for four types of base AV models in different driving environments including highway, roundabout, and urban environments (FIGS. 11-13).

Below, formulation of the AV training problem is discussed. The variables of the driving environment are denoted as X=[s(0), u(0), u(1), . . . , u(T)]∈Ω, where s(k) denotes the states (position, speed, heading, etc.) of the AV and surrounding background vehicles or other road users at the kth time step, u(k) denotes the maneuvers of surrounding background vehicles or other road users at the kth time step, T denotes the total time steps of each driving episode, and Ω denotes the space of the variables X. In the present embodiment, the goal of AV training is to optimize the AV policy w∈Π as

$${max}_{π ∈ Π} {𝔼}_{X ∼ P ( X )} [ f ( π , X ) ] , \qquad Equation ( 1 )$$

where f(⋅) denotes the objective function of AV training and X follows an underlying joint distribution P(X) in NDE. To keep the notation simple, it is left implicit in all cases that w is a function of neural network parameters θ. For safety training, the objective could be minimizing the overall crash rate as

$${min}_{π ∈ Π} {𝔼}_{X ∼ P ( X )} [ P ( {𝔸}_{π} \vert X ) ] , \qquad Equation ( 2 )$$

where [symbol] denotes the event of interest (e.g., vehicle crash), and P( [symbol] |X) denotes the event probability of the AV policy π in the driving environment X.

To address the curse of rarity and solve the AV training problem, deep learning approaches have been widely applied to handle the high variability and complexity of X. The key is to estimate the policy gradient at each training step for the current policy π as

$$δ {=}^{def} {𝔼}_{X ∼ P ( X )} [ {∇}_{π} P ( {𝔸}_{π} \vert X ) ] , \qquad Equation ( 3 )$$

where δ∈ [symbol] , d is the dimension of the gradient, and then the policy could be updated accordingly. For non-trivial AV policies, however, the event [symbol] is a rare event, so most P( [symbol] |X) and ∇_{π}P( [symbol] |X) are near zero. Therefore, estimating the policy gradient is essentially a rare-event estimation problem. If directly using the data collected in NDE, it is essentially a Monte Carlo estimation approach [Owen, A. B. Monte Carlo Theory, Methods and Examples. https://artowen.su.domains/mc/ (2013)] as

$${\hat{δ}}_{M C} {=}^{def} \frac{1}{n} {\sum }_{i = 1}^{n} {∇}_{π} P ( {𝔸}_{π} \vert {X}_{i} ) , {X}_{i} ∼ P ( X ) , \qquad Equation ( 4 )$$

where n is the number of samples used at each training step, and ∇_{π}P( [symbol] |Xᵢ) could be estimated through the policy gradient theorem [Sutton, R. S., & Barto, A. G. Reinforcement Learning: An Introduction. MIT press (2018)]. According to the properties of Monte Carlo estimation [Owen, A. B. Monte Carlo Theory, Methods and Examples. https://artowen.su.domains/mc/ (2013)], however, the estimator \hat{δ}_{MC} would suffer from a large variance, which severely hinders the learning effectiveness. Moreover, as \hat{δ}_{MC} is usually near zero, the signal-to-noise ratio is also low, which makes the problem even worse. This problem is called the CoR [Liu, H. X. and Feng, S. Curse of rarity for autonomous vehicles. Nat. Commun. 15, 4808 (2024)].

Below is a more rigorous elaboration on the CoR. Without loss of generality, the set of non-informative samples are defined as Φₙₒₙ⊂Ω and informative samples is defined as Φᵢₙ⊂Ω, their indicator functions [symbol] _{Φ}_{ₙₒₙ} and [symbol] _{Φ}_{ᵢₙ}, and an estimator of the policy gradient δ that only utilizes the informative samples is defined as

$${\hat{δ}}_{in} {=}^{def} \frac{1}{n} {\sum }_{i = 1}^{n} {∇}_{π} P ( {𝔸}_{π} \vert {X}_{i} ) {{Φ}_{i n}}_{} , {X}_{i} ∼ P ( X ) . \qquad Equation ( 5 )$$

Then, the following Lemma 1 is had, and the proof can be found in [Liu, H. X. and Feng, S. Curse of rarity for autonomous vehicles. Nat. Commun., 4808 (2024)].

Lemma 1

```
If Φₙₒₙ and Φᵢₙ satisfy the following conditions:
  (1) Φₙₒₙ ∩ Φᵢₙ = Ø, Φₙₒₙ ∪ Φᵢₙ = Ω;
  (2) [symbol]  _{X~P(X)}[∇_{π}P(A_{π}|X) [symbol]  _{Φ}_{ₙₒₙ}] = 0;
then one has the following properties:
  $( 1 ) {𝔼}_{X ∼ P ( X )} [ {\hat{δ}}_{MC} ] = {𝔼}_{X ∼ P ( X )} [ {\hat{δ}}_{in} ] ;$
  $( 2 ) {σ}_{P ( X )}^{2} ( {\hat{δ}}_{MC}^{( k )} ) \geq {σ}_{P ( X )}^{2} ( {\hat{δ}}_{in}^{( k )} ) , ∀ k = 1 , … d ; and$
  $( 3 ) {σ}_{P ( X )}^{2} ( {\hat{δ}}_{MC}^{( k )} ) \geq {ρ}_{{Φ}_{in}}^{- 1} {σ}_{P ( X )}^{2} ( {\hat{δ}}_{in}^{( k )} ) , ∀ k = 1 , … d , with the$
    assumption:
```

$${𝔼}_{X ∼ P ( X )} [ {G}_{k}^{2} ( {𝔸}_{π} \vert X ) {{Φ}_{i n}}_{} ] = {𝔼}_{X ∼ P ( X )} [ {G}_{k}^{2} ( {𝔸}_{π} \vert X ) ] {𝔼}_{X ∼ P ( X )} [ {{Φ}_{i n}}_{} ] , \\ ∀ k = 1 , … , d , \qquad Equation ( 6 )$$

where

$${\hat{δ}}_{MC}^{( k )} and {\hat{δ}}_{in}^{( k )}$$

are kth components of \hat{δ}_{MC} and \hat{δ}ᵢₙ, respectively, ρ_{Φ}_{ᵢₙ}= [symbol] _{˜P(X)}( [symbol] _{Φ}_{ᵢₙ})∈[0,1] is the expected proportion of the informative samples Φᵢₙ in all samples with the sampling distribution P(X), and G( [symbol] _{π}|X) [symbol] ∇_{π}P( [symbol] |X) is a random vector with G( [symbol] |X)=[G₁( [symbol] _{π}|X), . . . , G_{d}( [symbol] |X)]∈ [symbol] .

As a first remark, for AV safety training, the proportion of informative samples in all samples could be very small, in the order of 10⁻⁴˜10⁻⁶ or fewer, due to the rarity of safety-critical events in NDE. As the policy gradient ∇_{π}P( [symbol] |X) is mainly determined by the parameters of neural networks, it could exhibit a stationary uncertainty that is independent of the set Φᵢₙ. This is particularly true at the beginning of the learning process when the parameters are relatively random. Consequently, the assumption in Property 2 of Lemma 1 could be approximately satisfied, particularly at the beginning of the learning process. Therefore, the estimation variance of the traditional deep learning approaches based on Monte Carlo estimation could be very large.

As a second remark, Lemma 1 also indicates that if the set of informative samples Φᵢₙ could be identified, estimating the policy gradient utilizing only the informative samples has great potential to reduce the learning variance without loss of unbiasedness, thereby overcoming the CoR. However, how to define, identify, and effectively leverage informative samples for AV safety training is challenging. Prior to this work, this process is largely intuitive, for instance, many existing approaches only emphasize the crash event data or falsified cases [Menghi, Claudio, et al. “ARCH-COMP 2023 Category Report: Falsification.” Proceedings of 10th International Workshop on Applied. Verification of Continuous and Hybrid Systems (ARCH23), Vol. 96., pp. 151-169 (2023)], discussed as follows.

With respect to learning from the crash only, many existing approaches used to tackle the CoR challenge primarily focus on learning from the data where AVs fail. To be more specific, the estimator of these approaches can be represented as

$${\hat{δ}}_{Fail} {=}^{def} \frac{1}{n} {\sum }_{i = 1}^{n} {∇}_{π} P ( {𝔸}_{π} \vert {X}_{i} ) {{Φ}_{F}}_{} , {X}_{i} ∼ P ( X ) , \qquad Equation ( 7 )$$

where [symbol] (⋅) is an indicator function and Φ_{F} is the set of data samples where AV fails. However, these approaches are largely intuitive without theoretical foundation. Consequently, the definition of the set Φ_{F} does not satisfy the conditions of Φᵢₙ in Lemma 1, resulting in a severe learning biasedness, that is,

$${𝔼}_{X ∼ P ( X )} [ {\hat{δ}}_{Fail} ] \neq {𝔼}_{X ∼ P ( X )} [ {\hat{δ}}_{MC} ] . \qquad Equation ( 8 )$$

Without the unbiasedness guaranteed, the learning process could become misleading. That is the reason why learning-from-crash-only could suffer from the “seesaw effect” as discussed above.

Herein is proposed a dense learning approach to overcome the CoR challenge for AV training. Oftentimes, the key to dense learning is to define and identify the informative data samples for AV safety training, satisfying the conditions of Φᵢₙ in Lemma 1. To achieve this goal, the Lemma 1 is integrated with importance sampling theory to derive the optimal distribution of data samples. Although this optimal distribution is unavailable in practice, it provides guidance of defining and identifying the informative data for AV training. Then, the data was sampled based on the distribution, the non-informative samples were rejected, and the informative ones were effectively leveraged, resulting in the dense learning approach for AV training.

First, the optimal sampling distribution

$${q}_{π}^{*}$$

(X) and the corresponding policy estimator

$${\hat{δ}}_{IS}^{*}$$

are derived based on the importance sampling theory [Owen, A. B. Monte Carlo Theory, Methods and Examples. https://artowen.su.domains/mc/ (2013); Alain, G., Lamb, A., Sankar, C., Courville, A. and Bengio, Y., 2015. Variance reduction in sgd by distributed importance sampling. https://arxiv.org/abs/1511.06481] as

$${\hat{δ}}_{IS}^{*} {=}^{def} \frac{1}{n} {\sum }_{i = 1}^{n} [ \frac{P ( {X}_{i} )}{{q}_{π}^{*} ( {X}_{i} )} {∇}_{π} P ( {𝔸}_{π} \vert {X}_{i} ) ] , {X}_{i} ∼ {q}_{π}^{*} ( {X}_{i} ) , \qquad Equation ( 9 )$$

$${q}_{π}^{*} ( X ) ∝ {‖ {∇}_{π} P ( {𝔸}_{π} \vert X ) ‖}_{2} P ( X ) , \qquad Equation ( 10 )$$

where ∥⋅∥₂ denotes the l2 norm of the vector, and the symbol ∝ means ‘proportional to’. Eq. (10) provides the insights that the most informative data for AV training should contain all safety-critical events, both successful and failed, with probabilities proportional to their contributions to the AVs' policy gradient as well as their exposure frequencies in the real world. The major challenge of

$${\hat{δ}}_{IS}^{*}$$

is that ∥∇_{π}P( [symbol] |X)∥₂ cannot be accurately calculated for each episode X in practice and is dependent of the policy π, which is changing during the training process. Some existing studies tried to calculate ∇_{π}P( [symbol] |X) using the policy gradient theorem (see [Ciosek, K. and Whiteson, S., 2017, February. Offer: Off-environment reinforcement learning. In Proceedings of the AAAI conference on artificial intelligence (Vol. 31, No. 1)] for example), which introduces additional constraints and severely limits the effectiveness and applicability of the approach.

To address this challenge, Eq. (9-10) are hereby proposed to be utilized as a guidance to define and identify the informative samples for the dense learning approach. Therefore, instead of trying to calculate the exact values with severely limited applicability, ∥∇_{π}P( [symbol] |X)∥₂ is estimated as a classification task. Specifically, estimate ∥∇_{π}P( [symbol] |X)∥₂ is estimated as

$${‖ {∇}_{π} P ( {𝔸}_{π} \vert X ) ‖}_{2} \approx {X ∈ Φ}_{} {=}^{def} \{ \begin{matrix}1 , & X ∈ Φ \\ 0 , & X ∉ Φ\end{matrix} , Φ {=}^{def} \{ X ∈ Ω : ( {𝔸}_{n} \vert X ) = 1 and P ( {𝔸}_{π} \vert X ) < 1 or ( {𝔸}_{π} \vert X ) = 0 and P ( {𝔸}_{π} \vert X ) > 0 \} , \qquad Equation ( 11 )$$

where an avoidability analysis is conducted to approximate if a crash is avoidable (P( [symbol] |X)<1), and a safety metric was selected to approximate if a non-crash is a near-miss (P( [symbol] |X)>0). Specifically, a crash event was identified as avoidable if an evasive trajectory is still feasible after the vehicle state is being identified as safety-critical (see Supplementary Discussion below). And a non-crash event is identified as a near-miss if the minimum relative distance between the AV and background vehicles is below a pre-determined threshold (that is, 2.5 m).

Then, the estimator is obtained according to Eq. (9) as

$$\hat{δ} {=}^{def} \frac{1}{n} {\sum }_{i = 1}^{n} {∇}_{π} P ( {𝔸}_{π} \vert {X}_{i} ) , {X}_{i} ∼ {\hat{q}}_{π} ( {X}_{i} ) , \\ where \qquad Equation ( 12 )$$

$${\hat{q}}_{π} ( {X}_{i} ) {=}^{def} \frac{{{X}_{i} ∈ Φ}_{}}{{\sum }_{i = 1}^{N} {{X}_{i} ∈ Φ}_{} P ( {X}_{i} )} P ( {X}_{i} ) . \qquad Equation ( 13 )$$

Here, N denotes the total amount of data in the collected dataset.

Theorem 1 is then had, as shown in the proof below.

Proof of Property (1) of Theorem 1:

$$\begin{matrix}{𝔼}_{{\hat{q}}_{π}} [ \hat{δ} ] = {{𝔼}_{{\hat{q}}_{π}}}_{} [ \frac{1}{n} {\sum }_{i = 1}^{n} {∇}_{π} P ( {A}_{π} \vert {X}_{i} ) ] \\ = 𝔼 [ {∇}_{π} P ( {A}_{π} \vert {X}_{i} ) {\hat{q}}_{π} ( {X}_{i} ) ] \\ = 𝔼 [ {∇}_{π} P ( {A}_{π} \vert {X}_{i} ) {g}_{N}^{- 1} g ( {A}_{π} \vert {X}_{i} ) P ( {X}_{i} ) ] \\ = 𝔼 [ {∇}_{π} P ( {A}_{π} \vert {X}_{i} ) {g}_{N}^{- 1} {𝕀}_{{X}_{i} ∈ Φ} P ( {X}_{i} ) ] \\ = {g}_{N}^{- 1} 𝔼 [ {∇}_{π} P ( {A}_{π} \vert {X}_{i} ) P ( {X}_{i} ) {𝕀}_{{X}_{i} ∈ Φ} ]\end{matrix}$$

According to the definition of Φ in Eq. (11), one has

$$𝔼 [ {∇}_{π} P ( {A}_{π} \vert {X}_{i} ) P ( {X}_{i} ) {𝕀}_{{X}_{i} ∉ Φ} ] = 0 .$$

### Then, one has

$${𝔼}_{{\hat{q}}_{π}} [ \hat{δ} ] = {g}_{N}^{- 1} 𝔼 [ {∇}_{π} P ( {A}_{π} \vert {X}_{i} ) P ( {X}_{i} ) ] = {g}_{N}^{- 1} {𝔼}_{P} [ {\hat{δ}}_{M C} ] .$$

Proof of Property (2) of Theorem 1: The proof can be obtained from the definitions of \hat{δ} and \hat{δ}_{MC} in Eq. (12) and Eq. (4), respectively.

Proof of Property (3) of Theorem 1: Note that

$${g}_{N}^{- 1} \geq 1 .$$

For all k=1, . . . , d, one has

$$\begin{matrix}σ {}_{\hat{q} π}^{2} ( {\hat{δ}}^{( k )} ) = {Var}_{{\hat{q}}_{π}} ( {G}_{k} ( {𝔸}_{π} \vert {X}_{i} ) ) \\ = {𝔼}_{{\hat{q}}_{π}} [ {G}_{k}^{2} ( {𝔸}_{π} \vert {X}_{i} ) ] - {𝔼}_{{\hat{q}}_{π}}^{2} [ {G}_{k} ( {A}_{π} \vert {X}_{i} ) ] \\ = 𝔼 [ {G}_{k}^{2} ( {𝔸}_{π} \vert {X}_{i} ) {\hat{q}}_{π} ( {X}_{i} ) ] - {𝔼}^{2} [ {G}_{k} ( {A}_{π} \vert {X}_{i} ) {\hat{q}}_{π} ( {X}_{i} ) ] \\ = 𝔼 [ {G}_{k}^{2} ( {𝔸}_{π} \vert {X}_{i} ) {g}_{N}^{- 1} {𝕀}_{X ∈ Φ} P ( {X}_{i} ) ] - {𝔼}^{2} [ {G}_{k} ( {A}_{π} \vert {X}_{i} ) {g}_{N}^{- 1} {𝕀}_{X ∈ Φ} P ( {X}_{i} ) ] \\ = {g}_{N}^{- 1} {𝔼}_{P} [ {G}_{k}^{2} ( {𝔸}_{π} \vert {X}_{i} ) {𝕀}_{X ∈ Φ} ] - {g}_{N}^{- 2} {𝔼}_{P}^{2} [ {G}_{k} ( {A}_{π} \vert {XX}_{i} ) {𝕀}_{X ∈ Φ} ] \\ \leq {g}_{N}^{- 1} {𝔼}_{P} [ {G}_{k}^{2} ( {𝔸}_{π} \vert {X}_{i} ) ] - {g}_{N}^{- 2} {𝔼}_{P}^{2} [ {G}_{k} ( {A}_{π} \vert {X}_{i} ) ] \\ \leq {g}_{N}^{- 1} \{ {𝔼}_{P} [ {G}_{k}^{2} ( {𝔸}_{π} \vert {X}_{i} ) ] - {𝔼}_{P}^{2} [ {G}_{k} ( {A}_{π} \vert {X}_{i} ) ] \} \\ = {g}_{N}^{- 1} {σ}_{P}^{2} ( {\hat{δ}}_{M C}^{( k )} ) .\end{matrix}$$

For all k=1, . . . , d, one has

$$Δ {}_{\hat{q} π}^{2} ( {\hat{δ}}^{( k )} ) = \frac{σ {}_{\hat{q} π}^{2} [ {\hat{δ}}^{( k )} ]}{𝔼 {}_{\hat{q} π}^{2} [ {\hat{δ}}^{( k )} ]} = \frac{σ {}_{\hat{q} π}^{2} [ {\hat{δ}}^{( k )} ]}{g {}_{N}^{- 2} 𝔼 {}_{P}^{2} [ \hat{δ} {}_{MC}^{( k )} ]} \leq \frac{g {}_{N}^{- 2} σ {}_{P}^{2} [ \hat{δ} {}_{MC}^{( k )} ]}{g {}_{N}^{- 2} 𝔼 {}_{P}^{2} [ \hat{δ} {}_{MC}^{( k )} ]} = {g}_{N} Δ {}_{P}^{2} ( \hat{δ} {}_{MC}^{( k )} ) .$$

Proof of Property (4) of Theorem 1:

For all k=1, . . . , d, one has

$$\begin{matrix}σ {}_{\hat{q} π}^{2} ( {\hat{δ}}^{( k )} ) = {Var}_{\hat{q} π} ( {G}_{k} ( {𝔸}_{π} \vert {X}_{i} ) ) \\ = {𝔼}_{\hat{q} π} [ {G}_{k}^{2} ( {𝔸}_{π} \vert {X}_{i} ) ] - {𝔼}_{{\hat{q}}_{π}}^{2} [ {G}_{k} ( {A}_{π} \vert {X}_{i} ) ] \\ = 𝔼 [ {G}_{k}^{2} ( {𝔸}_{π} \vert {X}_{i} ) {\hat{q}}_{π} ( {X}_{i} ) ] - {𝔼}^{2} [ {G}_{k} ( {A}_{π} \vert {X}_{i} ) {\hat{q}}_{π} ( {X}_{i} ) ] \\ = 𝔼 [ {G}_{k}^{2} ( {𝔸}_{π} \vert {X}_{i} ) {g}_{N}^{- 1} {𝕀}_{{X}_{i ∈ Φ}} P ( {X}_{i} ) ] - {𝔼}^{2} [ {G}_{k} ( {A}_{π} \vert {X}_{i} ) g {}_{N}^{- 1} {𝕀}_{{X}_{i} ∈ Φ} P ( {X}_{i} ) ] ] \\ = {g}_{N}^{- 1} {𝔼}_{P} [ {G}_{k}^{2} ( {𝔸}_{π} \vert {X}_{i} ) {𝕀}_{{X}_{i} ∈ Φ} ] - {g}_{N}^{- 2} {𝔼}_{P}^{2} [ {G}_{k} ( {A}_{π} \vert {X}_{i} ) {𝕀}_{{X}_{i} ∈ Φ} ] \\ \leq {g}_{N}^{- 1} {𝔼}_{P} [ {G}_{k}^{2} ( {𝔸}_{π} \vert {X}_{i} ) ] {𝔼}_{P} [ {𝕀}_{{X}_{i} ∈ Φ} ] - {g}_{N}^{- 2} {𝔼}_{P}^{2} [ {G}_{k} ( {A}_{π} \vert {X}_{i} ) ] {𝔼}_{P} [ {𝕀}_{{X}_{i} ∈ Φ} ] \\ \leq {g}_{N}^{- 1} {𝔼}_{P} [ {𝕀}_{{X}_{i} ∈ Φ} ] \{ {𝔼}_{P} [ {G}_{k}^{2} ( {𝔸}_{π} \vert {X}_{i} ) ] - {𝔼}_{P}^{2} [ {G}_{k} ( {A}_{π} \vert {X}_{i} ) ] \} \\ = {g}_{N}^{- 1} {ρ}_{Φ} {σ}_{P}^{2} ( {\hat{δ}}_{M C}^{( k )} ) .\end{matrix}$$

For all k=1, . . . , d, one has

$$Δ {}_{\hat{q} π}^{2} ( {\hat{δ}}^{( k )} ) = \frac{σ {}_{\hat{q} π}^{2} [ {\hat{δ}}^{( k )} ]}{𝔼 {}_{\hat{q} π}^{2} [ {\hat{δ}}^{( k )} ]} = \frac{σ {}_{\hat{q} π}^{2} [ {\hat{δ}}^{( k )} ]}{g {}_{N}^{- 2} 𝔼 {}_{P}^{2} [ \hat{δ} {}_{MC}^{( k )} ]} \leq \frac{{g}_{N}^{- 1} {ρ}_{Φ} σ {}_{P}^{2} [ \hat{δ} {}_{MC}^{( k )} ]}{g {}_{N}^{- 2} 𝔼 {}_{P}^{2} [ \hat{δ} {}_{MC}^{( k )} ]} = {g}_{N} {ρ}_{Φ} Δ {}_{P}^{2} ( \hat{δ} {}_{MC}^{( k )} ) .$$

That concludes the proof of Theorem 1, which is presented below.

### Theorem 1

The estimator \hat{δ} has the following properties:

$${𝔼}_{X ∼ {\hat{q}}_{π} ( X )} [ \hat{δ} ] = {g}_{N}^{- 1} {𝔼}_{X ∼ P ( X )} [ {\hat{δ}}_{MC} ] ; \qquad ( 1 )$$

$$\hat{δ} = {\hat{δ}}_{M C} ; \qquad ( 2 )$$

$${Δ}_{{\hat{q}}_{π}}^{2} ( {\hat{δ}}^{( k )} ) \leq {g}_{N} {Δ}_{P}^{2} ( {\hat{δ}}_{M C}^{( k )} ) , ∀ k = 1 , … d ; \qquad ( 3 )$$

$${Δ}_{{\hat{q}}_{π}}^{2} ( {\hat{δ}}^{( k )} ) \leq {g}_{N} {ρ}_{Φ} {Δ}_{P}^{2} ( {\hat{δ}}_{M C}^{( k )} ) , ∀ k = 1 , … d , \qquad ( 4 )$$

with the assumption

$${𝔼}_{X ∼ P ( X )} [ {G}_{k}^{2} ( {𝔸}_{π} \vert X ) {𝕀}_{X ∈ Φ} ] = {𝔼}_{X ∼ P ( X )} [ {G}_{k}^{2} ( {𝔸}_{π} \vert X ) ] {𝔼}_{X ∼ P ( X )} [ {𝕀}_{X ∈ Φ} ] , ∀ k = 1 , … , d ; \qquad Equation ( 14 )$$

where

$${g}_{N} {=}^{def} {\sum }_{i = 1}^{N} {𝕀}_{{X}_{i ∈ Φ}} P ( {X}_{i} ) ∈ ( 0 , 1 ] , {\hat{δ}}^{( k )}$$

is the kth components of \hat{δ},

$${Δ}_{{\hat{q}}_{π}} ( {\hat{δ}}^{( k )} ) {=}^{def} \text{} {σ}_{{\hat{q}}_{π}} [ {\hat{δ}}^{( k )} ] / {𝔼}_{X ∼ {\hat{q}}_{π} ( X )} [ {\hat{δ}}^{( k )} ] and {Δ}_{P} ( {\hat{δ}}_{M C}^{( k )} ) {=}^{def} {σ}_{P} [ {\hat{δ}}_{M C}^{( k )} ] / {𝔼}_{X ∼ P ( X )} [ {\hat{δ}}_{M C} ]$$

are coefficients of variation, and ρ_{Φ} [symbol] [symbol] _{˜P(X)}[ [symbol] _{X∈Φ}]∈[0,1] expected proportion of the informative samples Φ in all samples with the sampling distribution P(X).

As a fourth remark, the first property of Theorem 1 ensures the unbiasedness of AV training regarding the direction of the gradient, which enables overcoming the seesaw effect. It is noted that, at least in the present embodiment, g_{N} is a constant and as the learning rate is usually adjustable, such a constant will not affect the learning process.

As a fifth remark, the second property indicates that the new estimator \hat{δ} has the same calculation equation as the Monte Carlo estimator \hat{δ}_{MC} (see Eq. (4) and Eq. (12)), and the only difference is the data sampling distribution. This is notable as the proposed approach could leverage all techniques that can be used for the Monte Carlo estimator (that is widely used for deep learning), without introducing any additional limitations. Therefore, this proposed approach could leverage the advances in deep learning but with a dramatically smaller learning variance, which ensures the effectiveness and applicability of such proposed approach.

As a sixth remark, third and fourth properties are obtained as Φ is a realization of defining and identifying the informative samples for the AV safety training task. Therefore, as indicated in Lemma 1, the coefficient of variation of \hat{δ} is dramstically smaller than that of the Monte Carlo approach. Moreover, \hat{δ} is an approximation of

$$\hat{δ} {}_{IS}^{*}$$

that has the minimum variance. Both indicate that \hat{δ} is an efficient policy gradient estimator for deep learning approaches associated with rare events. As the parameters of neural networks are usually randomly initialized, the assumption in Eq. (14) could be approximately satisfied, particularly at the beginning of the learning process, as discussed in the first remark above.

As a seventh remark, while the following investigation focuses on the deep reinforcement learning (DRL) tasks of AV safety training, Theorem 1 is also applicable to more generic deep learning tasks. Therefore, the proposed approach has the great potential to address the CoR challenge in generic deep learning tasks associated with rare events.

To further integrate the estimator \hat{δ} with DRL approaches, the policy gradient estimator of DRL is obtained as

$${\hat{δ}}_{D R L} {=}^{def} {\hat{Q}}_{π} ( {S}_{t} , {A}_{t} ) \frac{∇ π ( {A}_{t} \vert {S}_{t} )}{π ( {A}_{t} \vert {S}_{t} )} , ( {S}_{t} , {A}_{t} ) ∼ P ( X ) , \qquad Equation ( 15 )$$

where Sₜ and Aₜ are samples of the state and action following the distribution of episodes P(X) and under the policy π, Q_{π}(Sₜ, Aₜ) denotes the state-action value, \hat{Q}_{π}(Sₜ, Aₜ) is an unbiased estimation of Q_{π}(Sₜ, Aₜ), i.e., [symbol] [\hat{Q}_{π}(Sₜ, Aₜ)]=Q_{π}(Sₜ, Aₜ). As discussed in Remark 5, the proposed approach is compatible with existing techniques that can be used for the Monte Carlo estimator. Therefore, the estimator \hat{δ} is integrated with the dense deep reinforcement learning (D2RL) approach that was developed in a previous study for AV testing [Feng, S., Sun, H., Yan, X., Zhu, H., Zou, Z., Shen, S. and Liu, H. X., 2023. Dense reinforcement learning for safety validation of autonomous vehicles. Nature, 615(7953), pp. 620-627]. Although the AV training problem is different from the AV testing problem, the D2RL approach can still be beneficial to further reduce the learning variance by removing the non-safety-critical states and connecting the safety-critical ones. Therefore, a new estimator is obtained as

$${\hat{δ}}_{Dense} {=}^{def} {\hat{Q}}_{π} ( {S}_{t} , {A}_{t} ) \frac{∇ π ( {A}_{t} \vert {S}_{t} )}{π ( {A}_{t} \vert {S}_{t} )} {𝕀}_{{S}_{t} ∈ {𝕊}_{c}} , ( {S}_{t} , {A}_{t} ) ∼ {\hat{q}}_{π} ( X ) , \qquad Equation ( 16 )$$

where [symbol] [symbol] {s| [symbol] (q_{π}(s, a))≠q_{π}(s, a), ∃a} denotes the set of safety-critical states as defined in [Feng, S., Sun, H., Yan, X., Zhu, H., Zou, Z., Shen, S. and Liu, H. X., 2023. Dense reinforcement learning for safety validation of autonomous vehicles. Nature, 615(7953), pp. 620-627]. In embodiments, the AI-based safety metric is utilized to identify the safety-critical states.

Then Theorem 2 is had, as shown in the proof below.

Proof of Property (1) of Theorem 2: It is noted that [symbol] _{S}_{ₜ}_{∈Φ}_{_{D}}= [symbol] [symbol] _{X}_{ᵢ}_{∈Φ}. One has

$$\begin{matrix}{𝔼}_{{\hat{q}}_{π}} [ {\hat{δ}}_{Dense} ] = {𝔼}_{{\hat{q}}_{π}} [ {\hat{δ}}_{DRL} {{S}_{t} ∈ {𝕊}_{c}}_{} ] \\ = 𝔼 [ {\hat{δ}}_{DRL} {{S}_{t} ∈ {𝕊}_{c}}_{} {\hat{q}}_{π} ( {X}_{i} ) ] \\ = 𝔼 [ {\hat{δ}}_{DRL} {{S}_{t} ∈ {𝕊}_{c}}_{} {g}_{N}^{- 1} {{X}_{i} ∈ Φ}_{} P ( {X}_{i} ) ] \\ = {g}_{N}^{- 1} 𝔼 [ {\hat{δ}}_{DRL} {{S}_{t} ∈ {Φ}_{D}}_{} P ( {X}_{i} ) ]\end{matrix} .$$

According to the definitions of Φ and [symbol] , one has

$$𝔼 [ {\hat{δ}}_{DRL} {{S}_{t} ∉ {Φ}_{D}}_{} P ( {X}_{i} ) ] = 0.$$

### Then, one has

$${𝔼}_{{\hat{q}}_{π}} [ {\hat{δ}}_{Dense} ] = {g}_{N}^{- 1} 𝔼 [ {\hat{δ}}_{DRL} P ( {X}_{i} ) ] = {g}_{N}^{- 1} {𝔼}_{P} [ {\hat{δ}}_{DRL} ] .$$

Proof of Property (2) of Theorem 2: For all k=1, . . . , d, one has

$$\begin{matrix}{σ}_{{\hat{q}}_{π}}^{2} ( {\hat{δ}}_{Dense}^{( k )} ) = {Var}_{{\hat{q}}_{π}} ( {\hat{δ}}_{DRL}^{( k )} {{S}_{t} ∈ {𝕊}_{c}}_{} ) \\ = {𝔼}_{{\hat{q}}_{π}} [ {( {\hat{δ}}_{DRL}^{( k )} )}^{2} {{S}_{t} ∈ {𝕊}_{c}}_{} ] - {𝔼}_{{\hat{q}}_{π}}^{2} [ {\hat{δ}}_{DRL}^{( k )} {{S}_{t} ∈ {𝕊}_{c}}_{} ] \\ = 𝔼 [ {( {\hat{δ}}_{DRL}^{( k )} )}^{2} {{S}_{t} ∈ {𝕊}_{c}}_{} {\hat{q}}_{π} ( {X}_{i} ) ] - {𝔼}^{2} [ {\hat{δ}}_{DRL}^{( k )} {{S}_{t} ∈ {𝕊}_{c}}_{} {\hat{q}}_{π} ( {X}_{i} ) ] \\ = 𝔼 [ {( {\hat{δ}}_{DRL}^{( k )} )}^{2} {{S}_{t} ∈ {𝕊}_{c}}_{} {g}_{N}^{- 1} {{X}_{i} ∈ Φ}_{} P ( {X}_{i} ) ] - \\ {𝔼}^{2} [ {\hat{δ}}_{DRL}^{( k )} {{S}_{t} ∈ {𝕊}_{c}}_{} {g}_{N}^{- 1} {{X}_{i} ∈ Φ}_{} P ( {X}_{i} ) ] \\ = {g}_{N}^{- 1} {𝔼}_{P} [ {( {\hat{δ}}_{DRL}^{( k )} )}^{2} {{S}_{t} ∈ {Φ}_{D}}_{} ] - {g}_{N}^{- 2} {𝔼}_{P}^{2} [ {\hat{δ}}_{DRL}^{( k )} {{S}_{t} ∈ {Φ}_{D}}_{} ] \\ \leq {g}_{N}^{- 1} {𝔼}_{P} [ {( {\hat{δ}}_{DRL}^{( k )} )}^{2} ] - {g}_{N}^{- 2} {𝔼}_{P}^{2} [ {\hat{δ}}_{DRL}^{( k )} ] \\ \leq {g}_{N}^{- 1} \{ {𝔼}_{P} [ {( {\hat{δ}}_{DRL}^{( k )} )}^{2} ] - {𝔼}_{P}^{2} [ {\hat{δ}}_{DRL}^{( k )} ] \} \\ = {g}_{N}^{- 1} {σ}_{P}^{2} ( {\hat{δ}}_{DRL}^{( k )} )\end{matrix} .$$

For all k=1, . . . , d, one has

$${Δ}_{{\hat{q}}_{π}}^{2} ( {\hat{δ}}_{Dense}^{( k )} ) = \frac{{σ}_{{\hat{q}}_{π}}^{2} ( {\hat{δ}}_{Dense}^{( k )} )}{{𝔼}_{{\hat{q}}_{π}}^{2} [ {\hat{δ}}_{Dense}^{( k )} ]} = \frac{{σ}_{{\hat{q}}_{π}}^{2} ( {\hat{δ}}_{Dense}^{( k )} )}{{g}_{N}^{- 2} {𝔼}_{P}^{2} [ {\hat{δ}}_{DRL}^{( k )} ]} \leq \frac{{g}_{N}^{- 1} {σ}_{P}^{2} ( {\hat{δ}}_{DRL}^{( k )} )}{{g}_{N}^{- 2} {𝔼}_{P}^{2} [ {\hat{δ}}_{DRL}^{( k )} ]} = {g}_{N} {Δ}_{P}^{2} ( {\hat{δ}}_{DRL}^{( k )} ) .$$

Proof of Property (3) of Theorem 2: For all k=1, . . . , d, one has

$$\begin{matrix}{σ}_{{\hat{q}}_{π}}^{2} ( {\hat{δ}}_{Dense}^{( k )} ) = {Var}_{{\hat{q}}_{π}} ( {\hat{δ}}_{Dense}^{( k )} ) \\ = {𝔼}_{{\hat{q}}_{π}} [ {( {\hat{δ}}_{Dense}^{( k )} )}^{2} ] - {𝔼}_{{\hat{q}}_{π}}^{2} [ {\hat{δ}}_{Dense}^{( k )} ] \\ = 𝔼 [ {( {\hat{δ}}_{Dense}^{( k )} )}^{2} {\hat{q}}_{π} ( {X}_{i} ) ] - {𝔼}^{2} [ {\hat{δ}}_{Dense}^{( k )} {\hat{q}}_{π} ( {X}_{i} ) ] \\ = 𝔼 [ {( {\hat{δ}}_{Dense}^{( k )} )}^{2} {g}_{N}^{- 1} {{X}_{i} ∈ Φ}_{} P ( {X}_{i} ) ] - \\ {𝔼}^{2} [ {\hat{δ}}_{Dense}^{( k )} {g}_{N}^{- 1} {{X}_{i} ∈ Φ}_{} P ( {X}_{i} ) ] \\ = {g}_{N}^{- 1} {𝔼}_{P} [ {( {\hat{δ}}_{Dense}^{( k )} )}^{2} {{X}_{i} ∈ Φ}_{} ] - {g}_{N}^{- 2} {𝔼}_{P}^{2} [ {\hat{δ}}_{Dense}^{( k )} {{X}_{i} ∈ Φ}_{} ] \\ \leq {g}_{N}^{- 1} {𝔼}_{P} [ {( {\hat{δ}}_{Dense}^{( k )} )}^{2} ] {𝔼}_{P} [ {{X}_{i} ∈ Φ}_{} ] - {g}_{N}^{- 2} {𝔼}_{P}^{2} [ {\hat{δ}}_{Dense}^{( k )} ] {𝔼}_{P} [ {{X}_{i} ∈ Φ}_{} ] \\ \leq {g}_{N}^{- 1} {𝔼}_{P} [ {{X}_{i} ∈ Φ}_{} ] \{ {𝔼}_{P} [ {( {\hat{δ}}_{Dense}^{( k )} )}^{2} ] - {𝔼}_{P}^{2} [ {\hat{δ}}_{Dense}^{( k )} ] \} \\ = {g}_{N}^{- 1} {ρ}_{Φ} {σ}_{P}^{2} ( {\hat{δ}}_{Dense}^{( k )} )\end{matrix} .$$

For all k=1, . . . , d, one has

$${Δ}_{{\hat{q}}_{π}}^{2} ( {\hat{δ}}_{Dense}^{( k )} ) = \frac{{σ}_{{\hat{q}}_{π}}^{2} ( {\hat{δ}}_{Dense}^{( k )} )}{{𝔼}_{{\hat{q}}_{π}}^{2} [ {\hat{δ}}_{Dense}^{( k )} ]} = \frac{{σ}_{{\hat{q}}_{π}}^{2} ( {\hat{δ}}_{Dense}^{( k )} )}{{g}_{N}^{- 2} {𝔼}_{P}^{2} [ {\hat{δ}}_{DRL}^{( k )} ]} \leq \frac{{g}_{N}^{- 1} {ρ}_{Φ} {σ}_{P}^{2} ( {\hat{δ}}_{Dense}^{( k )} )}{{g}_{N}^{- 2} {𝔼}_{P}^{2} [ {\hat{δ}}_{Dense}^{( k )} ]} = {g}_{N} {ρ}_{Φ} {Δ}_{P}^{2} ( {\hat{δ}}_{Dense}^{( k )} ) .$$

Proof of Property (4) of Theorem 2: For all k=1, . . . , d, one has

$$\begin{matrix}{σ}_{{\hat{q}}_{π}}^{2} ( {\hat{δ}}_{Dense}^{( k )} ) = {Var}_{{\hat{q}}_{π}} ( {\hat{δ}}_{DRL}^{( k )} {{S}_{t} ∈ {𝕊}_{c}}_{} ) \\ = {𝔼}_{{\hat{q}}_{π}} [ {( {\hat{δ}}_{DRL}^{( k )} )}^{2} {{S}_{t} ∈ {𝕊}_{c}}_{} ] - {𝔼}_{{\hat{q}}_{π}}^{2} [ {\hat{δ}}_{DRL}^{( k )} {{S}_{t} ∈ {𝕊}_{c}}_{} ] \\ = 𝔼 [ {( {\hat{δ}}_{DRL}^{( k )} )}^{2} {{S}_{t} ∈ {𝕊}_{c}}_{} {\hat{q}}_{π} ( {X}_{i} ) ] - {𝔼}^{2} [ {\hat{δ}}_{DRL}^{( k )} {{S}_{t} ∈ {𝕊}_{c}}_{} {\hat{q}}_{π} ( {X}_{i} ) ] \\ = 𝔼 [ {( {\hat{δ}}_{DRL}^{( k )} )}^{2} {{S}_{t} ∈ {𝕊}_{c}}_{} {g}_{N}^{- 1} {{X}_{i} ∈ Φ}_{} P ( {X}_{i} ) ] - \\ {𝔼}^{2} [ {\hat{δ}}_{DRL}^{( k )} {{S}_{t} ∈ {𝕊}_{c}}_{} {g}_{N}^{- 1} {{X}_{i} ∈ Φ}_{} P ( {X}_{i} ) ] \\ = {g}_{N}^{- 1} {𝔼}_{P} [ {( {\hat{δ}}_{DRL}^{( k )} )}^{2} {{S}_{t} ∈ {Φ}_{D}}_{} ] - {g}_{N}^{- 2} {𝔼}_{P}^{2} [ {\hat{δ}}_{DRL}^{( k )} {{S}_{t} ∈ {Φ}_{D}}_{} ] \\ \leq {g}_{N}^{- 1} {𝔼}_{P} [ {( {\hat{δ}}_{DRL}^{( k )} )}^{2} ] {𝔼}_{P} [ {{S}_{t} ∈ {Φ}_{D}}_{} ] - {g}_{N}^{- 2} {𝔼}_{P}^{2} [ {\hat{δ}}_{DRL}^{( k )} ] {𝔼}_{P} [ {{S}_{t} ∈ {Φ}_{D}}_{} ] \\ \leq {g}_{N}^{- 1} {𝔼}_{P} [ {{S}_{t} ∈ {Φ}_{D}}_{} ] \{ {𝔼}_{P} [ {( {\hat{δ}}_{DRL}^{( k )} )}^{2} ] - {𝔼}_{P}^{2} [ {\hat{δ}}_{DRL}^{( k )} ] \} \\ = {g}_{N}^{- 1} {ρ}_{{Φ}_{D}} {σ}_{P}^{2} ( {\hat{δ}}_{DRL}^{( k )} )\end{matrix} .$$

For all k=1, . . . , d, one has

$${Δ}_{{\hat{q}}_{π}}^{2} ( {\hat{δ}}_{Dense}^{( k )} ) = \frac{{σ}_{{\hat{q}}_{π}}^{2} ( {\hat{δ}}_{Dense}^{( k )} )}{{𝔼}_{{\hat{q}}_{π}}^{2} [ {\hat{δ}}_{Dense}^{( k )} ]} = \frac{{σ}_{{\hat{q}}_{π}}^{2} ( {\hat{δ}}_{Dense}^{( k )} )}{{g}_{N}^{- 2} {𝔼}_{P}^{2} [ {\hat{δ}}_{DRL}^{( k )} ]} \leq \frac{{g}_{N}^{- 1} {ρ}_{{Φ}_{D}} {σ}_{P}^{2} ( {\hat{δ}}_{DRL}^{( k )} )}{{g}_{N}^{- 2} {𝔼}_{P}^{2} [ {\hat{δ}}_{DRL}^{( k )} ]} = {g}_{N} {ρ}_{{Φ}_{D}} {Δ}_{P}^{2} ( {\hat{δ}}_{DRL}^{( k )} ) .$$

This concludes the proof of Theorem 2, which is presented below.

Theorem 2

```
The estimator \hat{δ}_{Dense} has the following properties:
(1) [symbol]  _{X~}\hat{_{q}}_{_{π}}₍ₓ₎ [\hat{δ}_{Dense}] = g⁻¹_{N} [symbol] _{X~P(X)} [\hat{δ}_{DRL}];
$( 2 ) {Δ}_{{\hat{q}}_{π}}^{2} ( {\hat{δ}}_{Dense}^{( k )} ) \leq {g}_{N} {Δ}_{P}^{2} ( {\hat{δ}}_{DRL}^{( k )} ) , ∀ k = 1 , … d ,$
$( 3 ) {Δ}_{{\hat{q}}_{π}}^{2} ( {\hat{δ}}_{Dense}^{( k )} ) \leq {g}_{N} {ρ}_{Φ} {Δ}_{P}^{2} ( {\hat{δ}}_{Dense}^{( k )} ) , ∀ k = 1 , … d , with the$
    assumption in Eq. (14);
$( 4 ) {Δ}_{{\hat{q}}_{π}}^{2} ( {\hat{δ}}_{Dense}^{( k )} ) \leq {g}_{N} {ρ}_{{Φ}_{D}} {Δ}_{P}^{2} ( {\hat{δ}}_{DRL}^{( k )} ) , ∀ k = 1 , … d , with the$
    assumption
```

$${𝔼}_{X ∼ P ( X )} [ {( {\hat{δ}}_{DRL}^{( k )} )}^{2} {X ∈ {Φ}_{D}}_{} ] = {𝔼}_{X ∼ P ( X )} [ {( {\hat{δ}}_{DRL}^{( k )} )}^{2} ] {𝔼}_{X ∼ P ( X )} [ {X ∈ {Φ}_{D}}_{} ] , ∀ k = 1 , ... , d ; \qquad Equation ( 17 )$$

where

$${\hat{δ}}_{Dense}^{( k )} and {\hat{δ}}_{DRL}^{( k )}$$

are kth components of \hat{δ}_{Dense} and \hat{δ}_{DRL}, respectively,

$${Δ}_{{\hat{q}}_{π}} ( {\hat{δ}}_{Dense}^{( k )} ) {=}^{def} {σ}_{{\hat{q}}_{π}} ( {\hat{δ}}_{Dense}^{( k )} ) / {𝔼}_{X ∼ {\hat{q}}_{π} ( X )} [ {\hat{δ}}_{Dense}^{( k )} ] ,$$

$${Δ}_{P} ( {\hat{δ}}_{DRL}^{( k )} ) {=}^{def} {σ}_{P} ( {\hat{δ}}_{DRL}^{( k )} ) / {𝔼}_{X ∼ P ( X )} [ {\hat{δ}}_{DRL}^{( k )} ] , \\ {Δ}_{P} ( {\hat{δ}}_{Dense}^{( k )} ) {=}^{def} {σ}_{P} ( {\hat{δ}}_{Dense}^{( k )} ) / {𝔼}_{X ∼ P ( X )} [ {\hat{δ}}_{Dense}^{( k )} ]$$

are coefficients of variance, and ρ_{Φ}_{_{D}} [symbol] [symbol] _{˜P(X)}( [symbol] )∈[0,1] is the expected proportion of the informative states Φ_{D} [symbol] {Sₜ∈X: Sₜ∈ [symbol] and X∈Φ} in all sampled states with the sampling distribution P(X) and under the policy π.

As an eighth remark, Theorem 2 indicates that \hat{δ}_{Dense} is an unbiased and efficient policy gradient estimator of the DRL approaches, which is critical for overcoming the seesaw effect and CoR for AV training. As ρ_{Φ}_{_{D}} is smaller than ρ_{Φ}, the estimator \hat{δ}_{Dense} could further reduce the variance of policy gradient, compared with the estimator \hat{δ}.

As a ninth remark, as the policy gradient

$${\hat{δ}}_{DRL} {=}^{def} {\hat{Q}}_{π} ( {S}_{t} , {A}_{t} ) \frac{{∇}_{π} ( {A}_{t} \vert {S}_{t} )}{π ( {A}_{t} \vert {S}_{t} )}$$

is mainly determined by the parameters of neural networks, it could exhibit a stationary uncertainty that is independent of the set Φ_{D}. This is particularly true at the beginning of the learning process when the parameters are relatively random. Therefore, the assumptions in Eq. (17) could be approximately satisfied. It is noted that the assumptions are primarily for the theoretical analysis to be clean and are not strictly required in practice.

In regard to an offline resampling method, to realize the estimator \hat{δ}_{DRL}, an offline resampling mechanism is designed and used to resample and redistribute the collected episodic data according to the distribution \hat{q}_{π}(Xᵢ) as in Eq. (13). An avoidability analysis was developed to help approximate the distribution \hat{q}_{π}(Xᵢ). This mechanism is applicable for data collected through different venues, such as simulations, test tracks, and public roads. It also provides compatibility to integrate with purposely generated testing environments (such as ITE) where data is collected by a different distribution, and only the offline resampling distribution needs to be modified accordingly.

Hereafter is a discussion of AI-based safety metrics. Most existing safety metrics are primarily based on trajectory prediction of background road users with assumptions on their driving behaviors, which limit their effectiveness and generalization capability. This is particularly true for AV safety training, as the AV policy is changing during the training process. To address this issue, an AI-based safety metric is hereby introduced to identify the safety-critical states with both high precision and recall rates. The avoidability analysis approach was utilized to provide ground-truth labels for the large-scale naturalistic trajectory datasets. Specifically, all snapshots where a crash is unavoidable with evasive driving behaviors are labeled as positive, while others are labeled as negative. Because unavoidable snapshots are rare, existing training approaches suffer from the severely unbalanced data issue [Johnson, J. M. and Khoshgoftaar, T. M., 2019. Survey on deep learning with class imbalance. Journal of Big Data, 6(1), pp. 1-54]. Instead of rebalancing the data before the training, which could introduce the biasedness for training, it is hereby proposed to resample positive and negative snapshots from all the data to create balanced training data batches in each training step. In this way, the training data in each training step is rebalanced and densified, while the unbiasedness for the overall training process is retained. Results demonstrate that the proposed approach enables a much better precision and recall performance than existing safety metrics.

In regard to what is termed retrospective data densification, ideally, as the policy π is changing during the training process, the episodic data should be re-collected according to the new policy at each training step. However, this is severely inefficient and even infeasible in practice, particularly for on-road data collection. Therefore, an off-policy mechanism is needed to fill the policy gap. A retrospective data densification mechanism is designed and used to re-evaluate the collected data for the safety-critical driving agent through a counterfactual simulation. This mechanism could update the values of [symbol] (A_{π}|X) and P(A_{π}|X) in Eq. (11), so the data resampling distribution \hat{q}_{π}(Xᵢ) could be updated for the new AV policy, which reduces the overall policy gap.

The counterfactual simulation [Scanlon, J. M., Kusano, K. D., Daniel, T., Alderson, C., Ogle, A. and Victor, T., 2021. Waymo simulated driving behavior in reconstructed fatal crashes within an autonomous vehicle operating domain. Accident Analysis & Prevention, 163, p. 106454] is utilized to re-evaluate the safety performance of the AV policy and collect the training data. In each simulation, the base AV model with the safety-critical driving agent is responsible for the planning task of the simulated AV. The safety-critical driving agent handles all the safety-critical states identified by the AI-based safety metric; otherwise, the base AV model takes control. Calibrated non-linear bicycle models are used to simulate the motion of the AV with control command (e.g., steering angle and acceleration) inputs from the planning tasks. Specifically, in the present embodiment, the dynamic bicycle model is employed when AV speed is greater than 20 m/s and the kinematic bicycle model for other cases, leveraging their modeling strengthens for different situations [Johnson, J. M. and Khoshgoftaar, T. M., 2019. Survey on deep learning with class imbalance. Journal of Big Data, 6(1), pp. 1-54]. The trajectories of the background vehicles are replayed based on the recorded data until the recorded trajectories reach their end. At least in the present embodiment, for crash trajectories, if the safety-critical driving agent could avoid the original collision in the counterfactual simulation, re-simulate the driving behaviors of the background vehicles after the original collision moment need to be re-simulated to interact with the safety-critical driving agent, until the collision could be avoided completely or a new collision occurs. Specifically, in the present implementation, the background vehicles were simulated by a predefined driving model, such as the IDM and SL2015 provided by SUMO [Lopez, P. et al. Microscopic traffic simulation using sumo. International Conference on Intelligent Transportation Systems (ITSC), 2575-2582 (IEEE, 2018)]. The simulation will be terminated either upon collision or after a certain duration has elapsed.

Herein is provided an intelligent testing environment for efficient data collection, as made apparent from the following discussion. As ∥∇_{π}P(A_{π}|X)∥₂ is zero for most episodic data X and non-trivial AV policies π, most data collected in NDE has little information for AV training and will be rejected by the offline sampling mechanism as Eq. (13). To improve the data collection efficiency, the intelligent testing environment (ITE) that was developed in a previous study [Feng, S., Sun, H., Yan, X., Zhu, H., Zou, Z., Shen, S. and Liu, H. X., 2023. Dense reinforcement learning for safety validation of autonomous vehicles. Nature, 615(7953), pp. 620-627] is utilized, in that AI-based background agents are trained to test AVs in an accelerated mode, without loss of unbiasedness. Specifically, ITE will provide a dataset with a new distribution X˜q_{ITE}(X), each episode of data with a weight W_{ITE}(X)=P(X)/q_{ITE}(X), which contains much more valuable safety-critical episodes. To leverage this dataset without loss of unbiasedness, the safety-critical episodes are resampled by the distribution proportional to their weights W_{ITE}(X) and then resampled according to Eq. (13). It was found out that, with the dense learning approach, ITE could accelerate the collection of safety-critical data by multiple orders of magnitude without loss of unbiasedness, which dramatically accelerates the training process of AVs' overall safety performance. It is contemplated that this approach opens the door for integrating AV testing and training together, accelerating both fields, which deserves further investigation.

In regard to training settings of or for dense learning, the dense learning approach in highways, roundabouts, and urban environments, respectively, is implemented. To keep the fidelity and efficiency of the simulations, the NDE simulation and ITE as described in [Feng, S., Sun, H., Yan, X., Zhu, H., Zou, Z., Shen, S. and Liu, H. X., 2023. Dense reinforcement learning for safety validation of autonomous vehicles. Nature, 615(7953), pp. 620-627] and [Yan, X., Zou, Z., Feng, S., Zhu, H., Sun, H. and Liu, H. X., 2023. Learning naturalistic driving environment with statistical realism. Nature Communications, 14(1), p. 2037] are utilized. The PPO algorithm developed on the RLLIB 1.11.0 platform [Liang, Eric, et al. “RLlib: Abstractions for distributed reinforcement learning.” International conference on machine learning. PMLR, 2018] was applied to parallelly train the safety-critical driving agent on 400 CPU cores and 2800 GB memory high-performance computation cluster at the University of Michigan, Ann Arbor. A three-layer fully connected neural network was created, and this neural network had 256 neurons in each layer, to represent the safety-critical driving agent. The neural network received input data comprising the states of up to 6 background vehicles located within 30 m from the AV, where its output is the AV's acceleration and steering angle. Specifically, for the highway environment, the acceleration spanned from −4 m/s² to 2 m/s², and the steering angle varied between −10 degrees and 10 degrees; for roundabout environments, the acceleration ranged from −8 m/s² to 4.5 m/s², and the steering angle covered a range from −45 degrees to 45 degrees; and for the urban environment, the acceleration exhibited a range between −7 m/s² and 2.5 m/s², while the steering angle was within the −10 degrees to 10 degrees range. The learning rate was set to 10⁻⁵ and the discount factor to 0.99. In each training iteration, a total of 50,000 timesteps were used to train the neural network for 30 times. For each driving episode, the reward function is set to −1 for an AV-involved crash and 0 for others.

Field tests were performed, and the following provides an overview of the field testing settings used. The vehicle under test is a Lincoln MKZ™ hybrid from Mcity™ at the University of Michigan, equipped with various sensors, including OTXS RT3003 RTK GPS, PointGrey™ camera, Velodyne™ 32 channel LiDAR, Delphi™ radars Xsens MTi™ GPS/IMU, etc. The AV also had the Nuvo-8208GC™ computer and the Dataspeed™ drive-by-wire system installed. The open-source full-stack autonomous driving system, Autoware™ [Kato, S., Tokunaga, S., Maruyama, Y., Maeda, S., Hirabayashi, M., Kitsukawa, Y., Monrroy, A., Ando, T., Fujii, Y. and Azumi, T. Autoware on board: Enabling autonomous vehicles with embedded systems. In 2018 ACM/IEEE 9th International Conference on Cyber-Physical Systems (ICCPS), pp. 287-296 (2018)], is applied as the base AV model. Specifically, after receiving the ego vehicle's position and velocity as well as background vehicles' information, the future path is generated based on OpenPlanner™ 1.13 [Darweesh, H. et al. Open source integrated planner for autonomous navigation in highly dynamic environments. J. Robot. Mechatron. 29, 668-684 (2017)]. The pure pursuit algorithm was applied to convert the planned trajectory into the velocity and yaw rate and then used a proportional-integral-derivative controller provided by DataSpeed™ Inc. to further convert them into the vehicle by-wire control commands, that is, steering angle, throttle, and brake percentages. When the AI-based safety metric alerts in safety-critical situations, the safety-critical driving agent receives the normalized observation and outputs the steering angle and acceleration, which are further converted to the throttle and brake percentages.

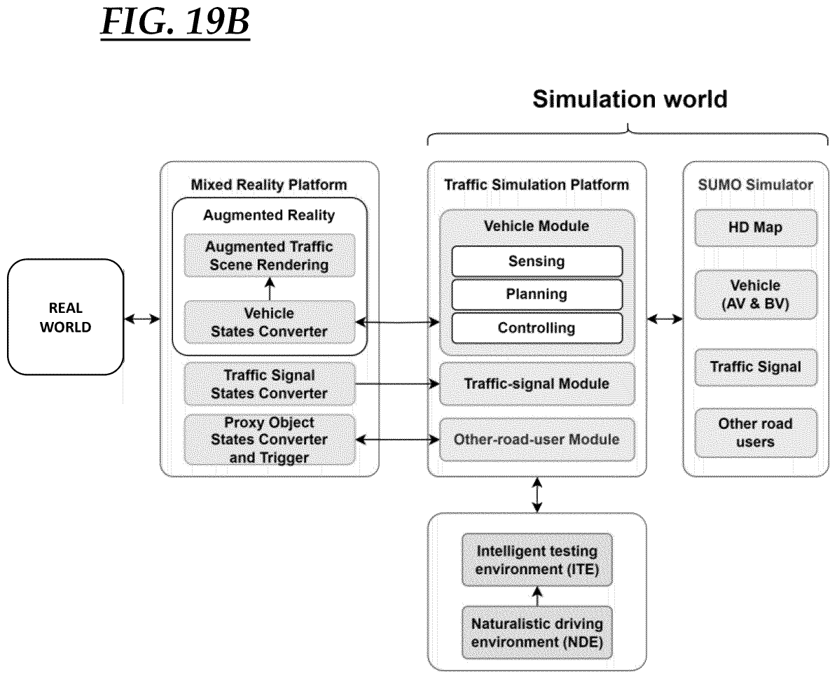

In the present embodiment, the mixed reality testing environment [Feng, S., Feng, Y., Yan, X., Shen, S., Xu, S. and Liu, H. X., 2020. Safety assessment of highly automated driving systems in test tracks: A new framework. Accident Analysis & Prevention, 144, p. 105664] was applied to efficiently evaluate the safety performance of AVs at Mcity™, which is one of the leading testing facilities for AV development. The states of the background vehicles were forwarded from the simulation world and the signal information from the physical testing track to the AV through the Internet. Simultaneously, the states of the AV as well as proxy objects and the signal information were synchronized into the simulation world, and the behaviors of virtual background vehicles were determined according to NDE or ITE. Besides, the virtual background vehicles were rendered and blended on the front camera's view using pyrender [Chang AX. et al. ShapeNet: An information-rich 3d model repository. https://arxiv.org/abs/1512.03012 (2015)]. To accelerate the testing process for evaluating the crash rates of the AV in NDE, the ITE that was developed in the previous study [Feng, S., Sun, H., Yan, X., Zhu, H., Zou, Z., Shen, S. and Liu, H. X., 2023. Dense reinforcement learning for safety validation of autonomous vehicles. Nature, 615(7953), pp. 620-627] was utilized, without loss of evaluation unbiasedness. A framework of the mixed reality testing framework can be found in FIGS. 19A-B.

In the present embodiment, the raw datasets that were used for modeling the naturalistic driving environment come from the Safety Pilot Model Deployment (SPMD) program [Bezzina, D., Sayer, J. Safety pilot model deployment: Test conductor team report. (Report No. DOT HS 812 171). Washington, DC: National Highway Traffic Safety Administration (2014)] and the Integrated Vehicle Based Safety System (IVBSS) [Sayer, J. et al. Integrated vehicle-based safety systems field operational test: final program report (No. FHWA-JPO-11-150; UMTRI-2010-36). United States. Joint Program Office for Intelligent Transportation Systems (2011)] at the University of Michigan, Ann Arbor, as well as the RounD dataset [Krajewski, R., Moers, T., Bock, J., Vater, L. and Eckstein, L. September. The round dataset: A drone dataset of road user trajectories at roundabouts in Germany. In 2020 IEEE 23rd International Conference on Intelligent Transportation Systems (ITSC) (pp. 1-6). (IEEE, 2020)].

The real-world driving environment is highly interactive and spatiotemporally complex. To faithfully reproduce real-world traffic, simulations must model diverse, nuanced, and long-tailed microscopic human driving behaviors. To capture the high-dimensional interactions among human drivers, the Generative Adversarial Imitation Learning (GAIL) paradigm [Karpathy, A., Tesla Inc, 2021. System and method for obtaining training data. U.S. patent application Ser. No. 17/250,825, U.S. Patent Application Publication No. 2021/0271259, Sep. 2, 2021, which is hereby incorporated by reference in its entirety] is employed, utilizing deep neural networks trained on extensive real-world data. By employing a Transformer-based architecture for both the generator and discriminator networks, one can accurately model human driving behaviors. The proposed simulation environment has been validated to reproduce real-world driving conditions with statistical realism, particularly for safety-critical events, including both crashes and near-misses. It can reproduce accurate crash rates, crash types, and crash severity, validated by five years of police crash reports from a complex roundabout in Ann Arbor, Michigan. The high fidelity of the simulation provides a trustworthy environment for AV development, minimizing the sim-to-real gap.

One significant challenge that hinders the development of autonomous vehicles (AVs) is the accurate and efficient assessment of their safety performance. The modeling of NDE could significantly address on the accuracy challenge of the safety performance assessment. However, due to the rarity of safety-critical events, hundreds of millions of miles are still needed to accurately assess the safety performance of AVs, which suffers from the severe inefficiency issue. To address this issue, the technology discussed herein was developed as an Intelligent Testing Environment (ITE) generation approach and using a Dense Deep Reinforcement Learning (D2RL) method, by sparse adversarial adjustments to the NDE model. Specifically, the D2RL approach was leveraged and the background vehicles were trained through a neural network to learn when to execute what adversarial maneuvers, which aimed to improve the testing efficiency and ensure evaluation unbiasedness. This resulted in an AI-based adversarial testing environment (here the ITE) that can reduce the required testing miles of AVs by multiple orders of magnitude while ensuring the testing unbiasedness. It was found that the ITE can also dramatically accelerate the training process of AVs by orders of magnitude.

In the present implementation, an avoidability analysis was conducted only if a driving state is identified as safety-critical by the AI-based safety metric discussed below. To determine whether a collision is avoidable, P(A_{π}|X)<1 in Eq. (11), the proposed approach is to determine if at least one evasive trajectory exists for the AV that can avoid the collision, given all near-future trajectories of surrounding background vehicles. Specifically, an optimization problem is formulated, where the decision variables are the action sequence of the AV, and the constraints are the collision avoidance between the AV trajectory and the background vehicles' trajectories. To avoid assumptions on the background vehicles' trajectories, their observed trajectories in the logged data were utilized as the “ground-truth” behaviors. If there is no feasible AV evasive trajectory, this crash event is considered unavoidable, that is P(A_{π}|X)=1; otherwise, P(A_{π}|X)<1 is set. More analysis can be found in [Seshia, S. A., Sadigh, D. and Sastry, S. S., 2022. Toward verified artificial intelligence. Commun. ACM, 65(7), pp. 46-55].

Although the ITE has accelerated the generation of training data by multiple orders of magnitude, it is still time-consuming to collect sufficient amount of data. Therefore, to improve the efficiency, the safety-critical driving agent system was trained for multiple steps and then recollect the training data. Specifically, as shown in Table 1, the training data was collected for five times in the highway driving experiments, requiring a total of 7.1×10⁴ cpu hour. Here, one CPU hour denotes running for one hour using one core of Intel Xeon Gold 6154™ Processor.

TABLE 1
Time consumption for training data generation.

| Number of training steps | Time consumption (CPU hour) |
|---|---|
| 0 | 3000 |
| 750 | 8000 |
| 1650 | 20000 |
| 2670 | 20000 |
| 3780 | 20000 |

It is noted note that the crucial factor of AV development is not the amount of time spent on data collection and training, but rather whether its safety performance can be further enhanced. The safety performance could reach stagnation no matter how many time steps are utilized for training or even get worse

The simulation software SUMO, the NDE models, the intelligent testing environment, the automated driving system Autoware™, and the RLLib platform with the implemented PPO algorithm are publicly available, as described in the text and the relevant references [Feng, S., Sun, H., Yan, X., Zhu, H., Zou, Z., Shen, S. and Liu, H. X., 2023. Dense reinforcement learning for safety validation of autonomous vehicles. Nature, 615(7953), pp. 620-627], [Kato, S., Tokunaga, S., Maruyama, Y., Maeda, S., Hirabayashi, M., Kitsukawa, Y., Monrroy, A., Ando, T., Fujii, Y. and Azumi, T. Autoware on board: Enabling autonomous vehicles with embedded systems. In 2018 ACM/IEEE 9th International Conference on Cyber-Physical Systems (ICCPS), pp. 287-296 (2018)], [Feng, S., Yan, X., Sun, H., Feng, Y., & Liu, H. X. Intelligent driving intelligence test for autonomous vehicles with naturalistic and adversarial environment. Nat. Commun. 12, 1-14 (2021)], [Lopez, P. et al. Microscopic traffic simulation using sumo. International Conference on Intelligent Transportation Systems (ITSC), 2575-2582 (IEEE, 2018)], and [Liang, Eric, et al. “RLlib: Abstractions for distributed reinforcement learning.” International conference on machine learning. PMLR, 2018].

With reference now to FIGS. 11-13, there is shown a performance evaluation of the dense learning approach in simulations, according to an embodiment. Specifically, FIG. 11 shows performance evaluation of the proposed dense learning approach for AV training in a multi-lane highway environment with the arrow in the overhead image denoting the AV driving route. At each data point of the proposed approach, the AV's performance in NDE was evaluated and the training data for the new AV was recollected. According to embodiments, the proposed approach could dramatically reduce the overall crash rate, crash rates of different crash types, and avoidable crash rate, compared with the base AV model. Here, the crash type diagram defined by the Fatality Analysis Reporting System [National Center for Statistics and Analysis. Fatality Analysis Reporting System (FARS) Analytical User's Manual, 1975-2018 (Report No. DOT HS 812 827). Washington, DC: National Highway Traffic Safety Administration. https://www.nhtsa.gov/research-data/fatality-analysis-reporting-system-fars. (2019)] was adopted. FIG. 12 shows performance evaluation of the proposed dense learning approach for AV training in roundabout scenarios. FIG. 13 shows performance evaluation of the proposed dense learning approach for AV training in the simulation model of an urban test track.

FIG. 11 shows the results of a multi-lane highway environment with a continuous driving distance of 400 meters. The same NDE was used as the one discussed above, trained a base AV model using the PPO algorithm, and implemented the responsibility-sensitive safety (RSS) model as the default safety guard. Through millions of tests of the base AV model in NDE, the crash rate as 2.71×10-5 crash per test was obtained. Then, the safety-critical driving agent was trained using the dense learning approach without RSS (FIG. 11, line 302). The results revealed a crash rate of 3.71×10-6, making an 86.3% reduction in comparison to the base AV model. When considering only avoidable crashes, the proposed approach demonstrated a remarkable 91.7% reduction in comparison to the base AV model. This suggests that the proposed approach significantly enhances the overall safety performance by approximately one order of magnitude, a substantial achievement. The integrated AV model with RSS was also evaluated, yielding a crash rate of 7.79×10-6, representing a 71.3% reduction compared to the base AV model (FIG. 11, line 304). While not as optimal as the model without RSS, due to the additional constraints introduced by RSS, the proposed approach still substantially improves overall safety performance. This is significant considering that many AV models may already have their safety guards or constraints in place. The evasive driving behaviors that the safety-critical driving agent learned were investigated and three typical ones, including emergency braking, rapid accelerating, and evasive lane changing, were identified.

Navigating through roundabouts poses a significant challenge for AVs due to the intricate interactions among AVs and the diverse mix of surrounding vehicles. To evaluate the effectiveness of the proposed approach in roundabout scenarios, the simulation experiments were expanded to a real-world four-armed roundabout in Germany, known for its high traffic volume and complex intersections. The realistic driving behaviors of background vehicles were generated in NDE with a Transformer-based learning approach [32: Yan, X., Zou, Z., Feng, S., Zhu, H., Sun, H. and Liu, H. X., 2023. Learning naturalistic driving environment with statistical realism. Nature Communications, 14(1), p. 2037], leveraging the naturalistic driving data in the RounD dataset. Using an advanced AV model with a sampling trajectory generation algorithm as the base AV model, it was demonstrated that the proposed approach significantly reduces the AV's crash rate by 74.5%, along with an 89.5% reduction in avoidable crash rates (FIG. 12).

The performance of the safety-critical driving agent was evaluated when used for AVs navigating continuously through urban environments. The digital twin of the Mcity™ test track in Ann Arbor, Michigan was utilized, where the behaviors of background vehicles in NDE were constructed based on the large-scale naturalistic driving data from SPMD and IVBSS programs. Two AV models as base models were used, with one being the default AV model in SUMO36 (the intelligent driving model (IDM) [Treiber, M., Hennecke, A. & Helbing, D. Congested traffic states in empirical observations and microscopic simulations. Phys. Rev. E 62, 1805 (2000)] and the SL2015 model [Lopez, P. et al. Microscopic traffic simulation using sumo. International Conference on Intelligent Transportation Systems (ITSC), 2575-2582 (IEEE, 2018)] in SUMO) and another one is Autoware™ [Kato, S., Tokunaga, S., Maruyama, Y., Maeda, S., Hirabayashi, M., Kitsukawa, Y., Monrroy, A., Ando, T., Fujii, Y. and Azumi, T. Autoware on board: Enabling autonomous vehicles with embedded systems. In 2018 ACM/IEEE 9th International Conference on Cyber-Physical Systems (ICCPS), pp. 287-296 (2018)], which is widely recognized as the leading open-source automated driving system. Results show that the proposed approach can reduce the overall crash rate of the SUMO AV model by 98.0% and reduce the avoidable crash rate by 98.9% (FIG. 13), representing a nearly two-orders-of-magnitude improvement. The identical safety-critical driving agent was integrated into Autoware™ without any additional refinement, and results indicate a reduction in the crash rate from 1.07×10-6 to 1.07×10-7, equating to a 90.0% enhancement in safety performance. This underscores the efficacy and adaptability of the proposed approach across various AV models.

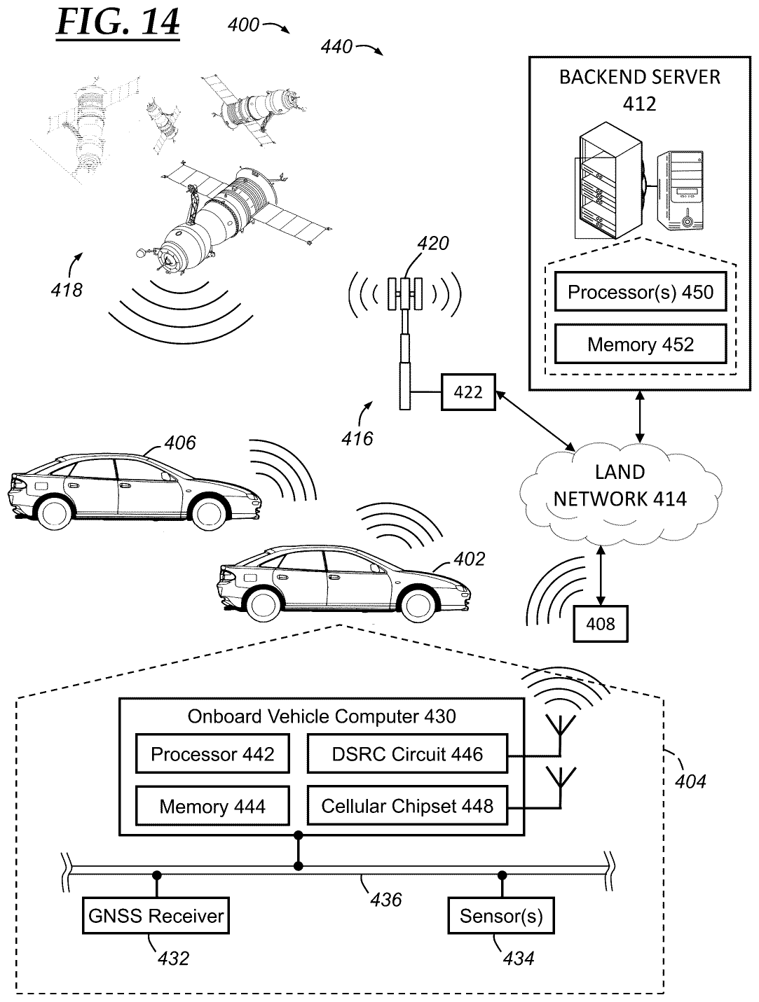

With reference now to FIG. 14, there is shown an operating environment that comprises a communications system 400, a host autonomous vehicle (AV) 402 having vehicle electronics 404, a real background vehicle (BV) 406, roadside unit(s) 408, a backend server 412, a land network 414, a wireless carrier system 416, and a constellation of global navigation satellite system (GNSS) satellites 418. The communications system 400 includes an AV testing system 440 that is comprised of at least one processor and memory coupled to the at least one processor, as is discussed more below. In certain embodiments, the real BV 406 may be omitted, such as where all of the BVs used for testing are virtual BVs. As used herein, a real BV is a BV that is a real, physical vehicle and a virtual BV is a BV that is simulated using a computer simulation. It should be appreciated that while the illustrated embodiment of FIG. 14 provides an example of one such communications system 400, the system and method described below may be used as part of various other communications systems.

The land network 414 may be a conventional land-based telecommunications network that is connected to one or more landline telephones and connects the wireless carrier system 416 to the backend server 412. For example, the land network 414 may include a public switched telephone network (PSTN) such as that used to provide hardwired telephony, packet-switched data communications, and the Internet infrastructure. One or more segments of the land network 414 may be implemented through the use of a standard wired network, a fiber or other optical network, a cable network, power lines, other wireless networks such as wireless local area networks (WLANs), or networks providing broadband wireless access (BWA), or any combination thereof.

The wireless carrier system 416 may be any suitable long-range data transmission system, such as a cellular telephone system. The wireless carrier system 416 is shown as including a single cellular tower 420; however, the wireless carrier system 416 may include additional cellular towers as well as one or more of the following components, which may depend on the cellular technology being used: base transceiver stations, mobile switching centers, base station controllers, evolved nodes (e.g., eNodeBs), mobility management entities (MMEs), serving and PGN gateways, etc., as well as any other networking components used to connect the wireless carrier system 416 with the land network 414 or to connect the wireless carrier system 416 with user equipment (UEs, e.g., which may include telematics equipment in the host AV 402 or the real BV 406), all of which is indicated generally at 422. The wireless carrier system 416 may implement any suitable communications technology, including for example GSM/GPRS technology, CDMA or CDMA2000 technology, LTE technology, 5G, etc. In at least one embodiment, the wireless carrier system 416 implements 5G cellular communication technology and includes suitable hardware and configuration. In some such embodiments, the wireless carrier system 416 provides a 5G network usable by the host AV 402 and/or real BV 406 for communicating with the backend server 412 or other computer/device remotely located from the host AV 402 and/or real BV 406. In general, the wireless carrier system 416, its components, the arrangement of its components, the interaction between the components, etc. is generally known in the art.

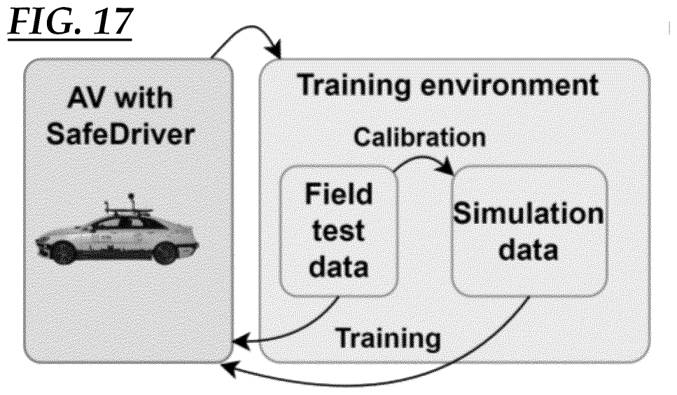

The backend server 412 may be used to provide a backend for one or more components of the host AV 402 and/or real BV 406, such as for purposes of receiving data from the vehicles 402,406 for purposes of carrying out the method 500 (FIG. 16) below and/or for other purposes, such as for sending over-the-air (OTA) updates to the vehicles 402,406. In at least one embodiment, the backend server 412 includes one or more computers or computing devices (collectively, “computers”). In some embodiments, the backend server 412 is used to store information pertaining to the vehicles 402,406, such as vehicle state information that may be used to evaluate performance of the host AV 402. The backend server 412 is a server that is carried out or hosted by one or more computers, each of which includes a processor and a non-transitory, computer-readable memory that is accessible by the processor. In at least one embodiment, the backend server 412 is used to provide configuration information (e.g., data, computer instructions) used as a part of AV testing of the host AV 402. The configuration information may be used to direct actions of one or more BVs that are present during testing of the host AV 402. In some embodiments, the configuration information causes a BV to operate according to a trained machine learning (ML) agent, as discussed below, which may be a trained safety-critical autonomous agent. The configuration information may be used by a simulator that simulates the BV(s) and/or their actions/movements. In one embodiment, the ML agent is trained using the disclosed D2RL approach and then this trained D2RL agent is used for determining actions of one or more BVs that are present during testing of the host AV 402. The training of the ML agent, including the data densification process, which is discussed in more detail below, may be carried out by the backend server 412.

It will be appreciated that the backend server 412 may actually include a plurality of servers that may be collocated or remotely located from one another, and that may be used for a variety of services. In some embodiments, one or more steps or functions described herein as being carried out by the backend server 412 may be carried out by cloud computing services and the actual processing may be carried out in a distributed manner. It should be appreciated, however, that the backend server 412, which is remote from the host AV 402, may be implemented in a variety of ways and is not to be limited to any particular configuration, type, or number of computing devices.

The backend server 412 is shown as including one or more processors 450 and non-transitory, computer-readable memory 452. In some embodiments, the backend server 412 may be configured so that, when computer instructions stored on the memory 452 are executed by the processor(s) 450, the backend server 412 causes certain steps and/or functionality to be carried out, such as any of the functionality attributed to the backend server 412 as discussed herein. The backend server 412 may be used for various purposes, such as to provide the vehicle information concerning the roadway on which it is operating and/or other information concerning the vehicle's environment. In some embodiments, the communications system 400 includes various backend servers that are used for various purposes.

In at least one embodiment, the backend server 412 is used to carry out one or more steps of the method 500 (FIG. 16) described below. For example, in one embodiment, the memory 452 stores computer instructions that, when executed by the at least one processor 450, cause one or more steps of the method 500 (FIG. 16) to be carried out. And, as mentioned above, the backend server 412 may be comprised of various computing devices that may be co-located or remotely located from one another. In one embodiment, a first computer subsystem of the backend server 412 may be used to carry out the Markov decision process editing step herein and another computer subsystem of the backend server 412 may be used to train a neural network using the edited Markov decision process. Then, for example, a third computer subsystem may be used to execute a ML agent for purposes of controlling operation of one or more BVs, such as the real BV 406 and virtual BV(s). In other embodiments, however, such steps or functions may be carried out by the same computing devices or computer subsystem or by other components of the communications system 400.

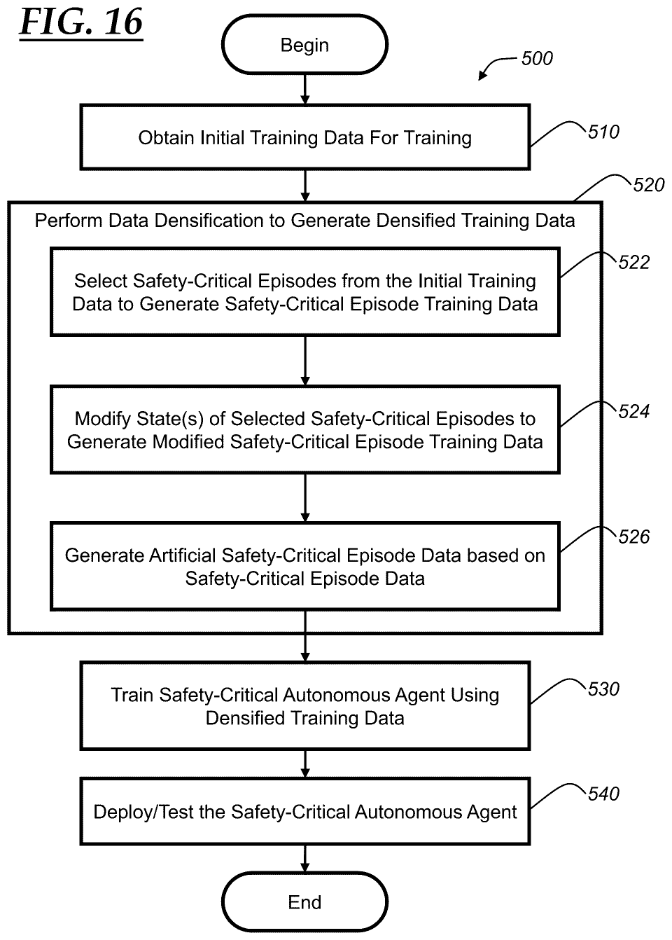

The host AV 402 is depicted in the illustrated embodiment as a passenger car, but it will be appreciated that any other vehicle including motorcycles, trucks, sports utility vehicles (SUVs), recreational vehicles (RVs), other vehicles or mobility devices that can be used on a roadway or sidewalk, etc., can also be used. As depicted in the illustrated embodiment, the host AV 402 includes the vehicle electronics 404. The vehicle electronics 404 include an onboard vehicle computer 430, a GNSS receiver 432, one or more sensors 434, and a vehicle communications bus 436. FIG. 14 provides an example of certain components of the vehicle electronics 404; however, it will be appreciated that, according to various embodiments, the vehicle electronics 404 may include one or more other components in addition to or in lieu of those components depicted in FIG. 14. FIG. 15 shows an exemplary vehicle that may be used as the exemplary host vehicle.

The real background vehicle (BV) 406 is a real vehicle, like the host AV 402, and may include the same or similar hardware as that of the host AV 402. Each of the components of the host AV 402 are hereby attributed to the real BV 406. The real BV 406 may include a different configuration or operating instructions than the host AV 402, as the host AV is the AV under test and real BV 406 is a BV used for purposes of testing the host AV. The real BV 406 may be controlled at least in part by the method discussed herein, which may be based on the disclosed D2RL approach. In some embodiments, the AV testing system 440 includes using the real BV 406 to test the host AV 402. As mentioned above, the real BV 406 is omitted, at least in some embodiments.

With reference back to the vehicle electronics 404 of the host AV 402, the global navigation satellite system (GNSS) receiver 432 receives radio signals from the constellation of GNSS satellites 418. The GNSS receiver 432 uses the received radio signals to generate location data that represents the location of the GNSS receiver 432 and, thus, the host AV 402 on which it is installed. In one embodiment, such as where the system 400 is within the United States, the GNSS receiver 432 may be a global positioning system (GPS) receiver. In another embodiment, such as where the system 40 is within Europe, the GNSS receiver 432 may be a GNSS receiver configured to be used with Galileo. In addition to the location data, which may represent a location as a geographical coordinate pair, the GNSS receiver 432 may also specify the time associated with each location. This time and location data that is obtained by a GNSS receiver based on GNSS signals is referred to as GNSS data. The location data may be used in conjunction with other data, such as map data that specifies attributes of roads, to identify information concerning the road on which the vehicle is travelling. As another example, the location data may be used to obtain weather information about the location at which the host AV 402 is located. The host AV 402 may also utilize real time kinematic (RTK) techniques, and may include a high-precision RTK module.

The one or more sensors 434 represent at least one onboard vehicle sensor that may be installed on the host AV 402 and used by the AV 402 for its autonomous operations and/or for obtaining data for testing or evaluation of the host AV 402. The sensor(s) 434 may include vehicle cameras, radar devices, lidar devices, ignition timing sensors, exhaust sensors, vehicle speed sensors, accelerometers, battery sensors, parking assist sensors, lane change and/or blind spot sensors, lane assist sensors, tire-pressure sensors, fluid level sensors (including a fuel level sensor), brake pad wear sensors, and rain or precipitation sensors. Generally, the sensor(s) 434 are used to obtain vehicle sensor data, which can include vehicle sensor values as measured or determined by the sensor. The sensor data from the sensor(s) 434 may be captured during testing and then evaluated as a part of evaluating the host AV 402 when under test.

The onboard vehicle computer 430 is an onboard computer in that it is carried by the host AV 402 and is considered a vehicle computer since it is a part of the vehicle electronics 404. The onboard vehicle computer 430 includes at least one processor 442 and non-transitory, computer-readable memory 444 that is accessible by the at least one processor 442. The onboard vehicle computer 430 is connected to the vehicle communications bus 436 and may send messages to, and receive messages from, other vehicle components using this bus 436. The onboard vehicle computer 430 also includes a short-range wireless communications (SRWC) or dedicated short range communication (DSRC) circuit 446 and a cellular chipset 448 that are used for wireless communications. The DSRC circuit 446 includes an antenna and is configured to carry out one or more SRWC technologies, such as any one or more of the IEEE 802.11 protocols (e.g., IEEE 802.11p, Wi-Fi™), WiMAX™, ZigBee™, Z-Wave™, Wi-Fi Direct™, Bluetooth™ (e.g., Bluetooth™ Low Energy (BLE)), and/or near field communication (NFC). In one embodiment, the DSRC circuit 446 may be used to carry out communications with the backend server 412—for example, the host AV 402 may use the DSRC circuit 446 to send messages to roadside unit(s) (RSU(s)) 408, which may then forward the messages to the backend server 412 via land network 414 to which the RSU 408 is connected. The cellular chipset 448 includes an antenna and is used for carrying out cellular communications or long-range radio communications with the wireless carrier system 416. And, in one embodiment, the cellular chipset 448 includes suitable 5G hardware and 5G configuration so that 5G communications may be carried out between the host AV 402 and the wireless carrier system 416, such as for purposes of carrying out communications between the host AV 402 and one or more remote devices/computers, such as those implementing the backend server 412.

With reference to FIG. 16, there is shown an embodiment of a method 500 of training a safety-critical autonomous agent. The method 500 is performed by the dense learning-based autonomous training system 10, at least in one embodiment.

The method 500 begins with step 510, wherein initial training data for training is obtained. The initial training data for training is data that is of the kind used for training in its pre-densified state. For example, in the context of training a safety-critical driving agent using the present method 500, the initial training data is AV driving episode data representing one or more AV driving episodes of a host vehicle. The initial training data is obtained by the dense learning-based autonomous training system 10 from any of a variety of ways, including downloading training data sets from an open source data store made available over the internet, downloading training data sets from one or more private, authorized data stores, recalling data from a database that stores captured driving or autonomous system episode data, etc. The method 500 continues to step 520.

In step 520, a data densification process is performed in order to generate densified training data from the initial training data. The method 500 is shown and described as using all three sub-steps 522-526; however, in other embodiments, one or more of the sub-steps may be omitted. In the present embodiment, the data densification process begins with sub-step 522, wherein safety-critical episodes from the initial training data are selected in order to generate safety-critical episode training data. This involves selecting informative driving episodes that contribute significantly to the policy gradient and exposure frequency. The method 500 continues to sub-step 524.

In sub-step 524, one or more states of one or more of the selected safety-critical episodes are modified in order to generate modified safety-critical episode training data. This is achieved by implementing an AI-based safety metric to identify and retain only the safety-critical states, thereby editing the decision-making Markov chain of the AV to enhance the relevance and quality of the training data. The method 500 continues to sub-step 526.

In sub-step 526, artificial safety-critical episode data is generated based on safety-critical episode data, such as the safety-critical episode training data and/or an output of the safety-critical autonomous agent. In embodiments, the artificial safety-critical episode data is generated through counterfactual simulation, which involves retrospectively re-evaluating and reclassifying data based on the updated AV policy. This process ensures that the training dataset remains relevant and informative as the AV policy evolves. The method 500 continues to step 530.

In step 530, a safety-critical autonomous agent is trained using the densified training data. In at least one embodiment, this step involves feeding the densified data into the machine learning model to improve the agent's decision-making capabilities in safety-critical scenarios, aiming to minimize the occurrence probability of rare but critical events. The method 500 continues to step 540.

In step 540, the safety-critical autonomous agent as trained (or the “trained safety-critical autonomous agent”) is deployed, tested, or otherwise provided in suitable form for execution. As discussed below, the proposed approach was tested and evaluated using a host vehicle at Mcity™ in Ann Arbor, Michigan. The safety-critical autonomous agent is represented by safety-critical autonomous agent data and is stored in memory. The method 500 ends.

To demonstrate the effectiveness of the proposed approach for real-world AVs, a Lincoln MKZ hybrid was outfitted with Autoware™ as the base AV model. Then, the proposed dense learning approach was employed to train a safety-critical driving agent and a comparative analysis of their safety performances during continuous driving in the physical test tracks at Mcity™ was conducted. A mixed-reality testing platform was developed, and this platform combined the physical road infrastructures, proxy physical objects, and a simulation environment, where information of the real world and simulation world is synchronized. One additional challenge for real AV training is caused by the so-called simulation-to-reality gap, where AV models developed in simulations may not seamlessly translate to real-world performance. In this work, the gap was bridged by iteratively improving the simulation models. Specifically, the same Autoware™ system was utilized in simulation as employed in the actual AV, mimicked the delay and latency characteristics of the real AV, and compensated for acceleration and deceleration effects induced by road slopes. Results demonstrated that, with this approach, the safety-critical driving agent trained in simulation effectively reduces the crash rate of the real AV from 1.44×10-6 to 1.42×10-7, making an impressive 90.1% improvement in the AV's safety performance. Recognizing that some crashes are unavoidable due to aggressive behaviors of background vehicles, the crash rate of avoidable crashes was further assessed, revealing a 98.8% reduction through the proposed approach.

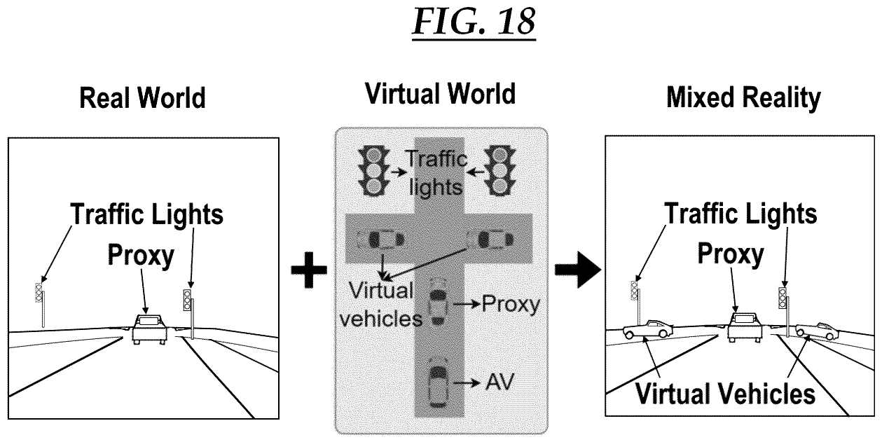

With reference now to FIGS. 17-22, there are shown an illustration of aspects of a solution to the simulation-to-reality gaps that exist for training AVs. FIG. 17 shows a training pipeline of the safety-critical driving agent for the real AV, where the field test data is iteratively utilized to fill the simulation-to-reality gap in simulations. By analyzing the accelerations of the real AV and the safety-critical driving agent command, the simulation-to-reality gaps could be obtained such as the time delay and the effect of road slope. The safety-critical driving agent model developed in FIG. 13 as the pre-trained model (Model I) and then fine-tuned the model for Autoware™ (Model II). After testing Model II for a few miles in the test track, the simulation-to-reality gap was narrowed by calibrating the simulation using the testing data, and then further fine-tuned the model (Model III) in the simulation with smaller gaps.

With reference back to FIG. 15, there is shown an illustration of a real AV under test, equipped with Autoware™, Lidar, cameras, on-board computer, by-wire controller, high-definition (HD) map, and RTK (Real-Time Kinematics) GPS (Global Positioning System). The AV under test was tested at the Mcity™ test track, which includes highways, roundabouts, intersections, urban streets, etc.

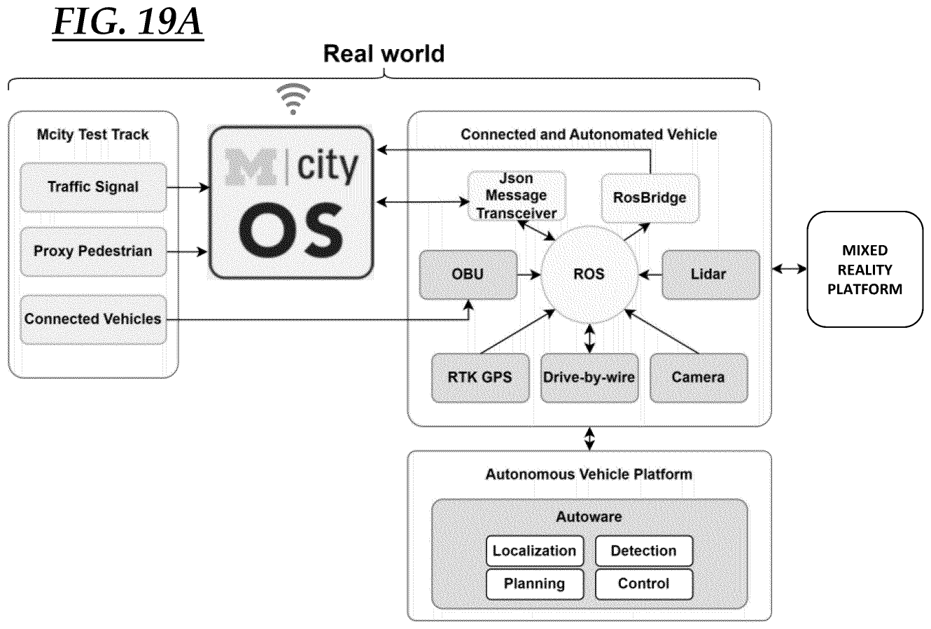

With reference now to FIG. 18 is an illustration of a mixed-reality environment combining simulated background vehicles with physical road infrastructure, proxy objects, and simulation. FIGS. 19A-B show an embodiment of a framework of the mixed reality testing environment at Mcity™ test track in Ann Arbor, Michigan.

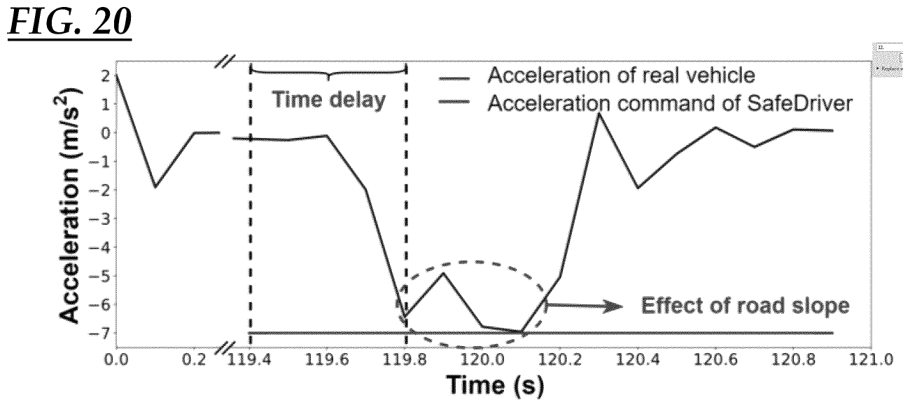

FIG. 20 depicts a graph showing acceleration over time for real vehicles and at command of the safety-critical driving autonomous agent. By analyzing the accelerations of the real AV and the Safety-critical driving agent command, the simulation-to-reality gaps could be obtained such as the time delay and the effect of road slope.

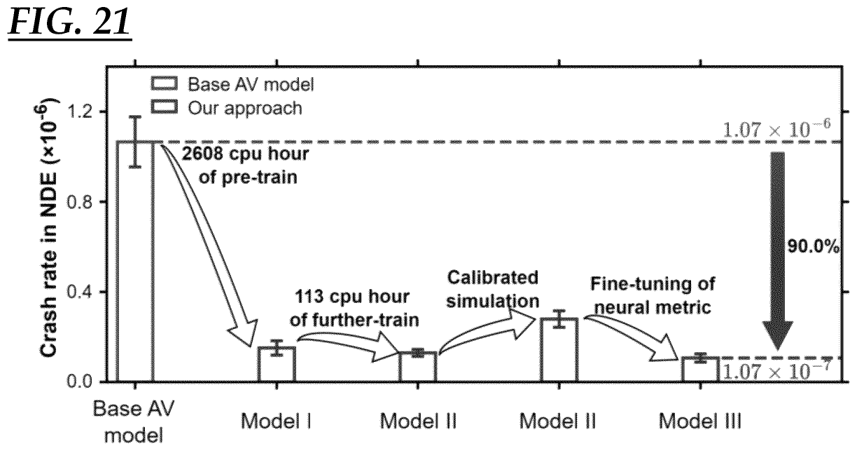

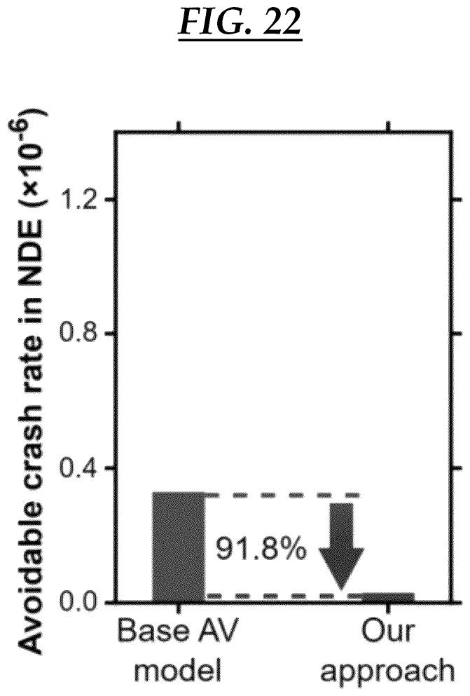

FIG. 21 depicts a graph of crash rates for a base AV model, Model I, Model II (before calibration simulation), Model II (after calibration simulation), and Model III, illustrating safety performances of different training iterations of AVs in the co-simulation of SUMO and Autoware™ at Mcity™. The error bar illustrates the standard deviation. The safety-critical driving agent model developed in FIG. 13 was utilized as the pre-trained model (Model I) and then fine-tuned the model for Autoware™ (Model II). After testing Model II for a few miles in the test track, the simulation-to-reality gap was narrowed by calibrating the simulation using the testing data, and then further fine-tuned the model (Model III) in the simulation with smaller gaps. FIG. 22 shows a graph of avoidable crash rates for the base AV model compared to those of the proposed approach.

The dense learning approach proposed herein is generally applicable to various deep learning problems that involve dealing with long-tailed scenarios and achieving high accuracy. This issue has been a long-standing challenge in multiple fields associated with safety-critical autonomous systems, such as medical robots and aerospace systems. Despite the significant advancements in AI systems such as AlphaGo and GPT, their application in safety-critical domains remains difficult due to the low tolerance for issues like hallucinations. The dense learning approach opens the door for leveraging AI techniques in the development of such systems. By reducing learning variance while ensuring unbiased learning, the proposed approach establishes a solid theoretical foundation for effectively learning from rare events. This capability allows for continual improvement of system performance in long-tailed scenarios—a task that is intractable for traditional deep learning approaches.

While AV companies have already collected a large amount of data, strategies for effectively utilizing this data to enhance AV safety performance remains unclear. Due to the rarity of safety-critical events, the information of these events is usually hidden within a vast amount of noisy data. One might think that this issue could be resolved by focusing on a small set of data related to these rare events. However, prior to this study, there was no theoretical foundation supporting this intuition, which greatly limited its effectiveness and could even lead to misleading results. The proposed dense learning approach addresses this challenge with a thorough theoretical analysis for defining, identifying, and effectively leveraging the set of informative data. To the best knowledge, this is the first methodological framework that constructs a closed-loop data platform for AVs, enabling the utilization of collected data for AV training. This is particularly significant considering AVs rely on larger neural networks and require more informative data for effective training.

In this development, it was found that a purposely generated testing environment such as ITE developed in previous work [U.S. Patent Application Publication No. 2023/0358640] could dramatically improve the efficiency of data collection for AV training. In embodiments, the main objective of AV testing is to estimate the probabilities of rare events given a specific AV policy, whereas AV training is to minimize these quantities in the entire AV policy space. This fundamental distinction makes the AV training considerably more challenging than AV testing. However, as a reliable performance estimation of a policy provides a solid foundation for further policy optimization, an efficient AV testing environment can significantly reduce the time and cost required to gather sufficient informative data for AV training. It is important to note that the present technology introduces a paradigm shift in AV training by presenting a framework that synergizes AI-based testing environments with training efforts. This symbiotic relationship holds the potential to accelerate advancements in both testing and training realms.

In one embodiment, the simulation system described in U.S. Patent Application Publication No. 2020/0065443 may be used for testing the safety-critical driving agent. This simulation system provides simulated virtual objects for use by a connected real vehicle (here, the host AV) during testing of the vehicle on a roadway. The discussion of the simulation system in paragraphs [0015]-[0021], [0047]-[0095] of U.S. Patent Application Publication No. 2020/0065443 as well as the method(s) discussed in paragraphs [0004]-[0014], [0022]-[0034], [0047]-[0049], and [0096]-[0106] of U.S. Patent Application Publication No. 2020/0065443 is hereby incorporated by reference. Such a simulation system may be used for testing the host AV in a real environment augmented by virtual vehicles (here, background vehicles) and, in particular, such a simulation system may be modified configured to include BVs that operate according to the trained safety-critical driving agent. In this way, at least according to some embodiments, naturalistic safety testing may be performed on the host AV in a real environment, and in a way so as to address the above-described curse of rarity and curse of dimensionality.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/of” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of training a safety-critical autonomous agent, wherein the method comprises:
obtaining initial training data to be used for training a safety-critical autonomous agent;
densifying the initial training data using a data densification process in order to generate densified training data, wherein the data densification process includes:
selecting safety-critical episodes from the initial training data in order to generate safety-critical episode training data; and/or
generating artificial safety-critical episode data representing one or more artificial safety-critical episodes, wherein the artificial safety-critical episode data is generated based on at least one safety-critical episode;
wherein the densified training data is or is based on one or both of the safety-critical episode training data and the artificial safety-critical episode data; and
training a safety-critical autonomous agent using the densified training data.

2. The method of claim 1, wherein the data densification process further includes:
modifying one or more states of one or more safety-critical episodes in order to remove non-informative states.

3. The method of claim 2, wherein the data densification process includes selecting safety-critical episodes from the initial training data in order to generate the safety-critical episode training data, and wherein the one or more safety-critical episodes modified to remove the non-informative states includes at least one of the selected safety-critical episodes.

4. The method of claim 1, wherein the data densification process includes:
selecting the safety-critical episodes from the initial training data;
modifying one or more states of one or more of the selected safety-critical episodes in order to remove non-informative states; and
generating the artificial safety-critical episode data representing one or more artificial safety-critical episodes, wherein the artificial safety-critical episode data is generated based on at least one safety-critical episode.

5. The method of claim 4, wherein the artificial safety-critical episode data is generated as a result of a counterfactual simulation performed using output data of the safety-critical autonomous agent that was generated based on the at least one safety-critical episode.

6. The method of claim 5, wherein the at least one safety-critical episode is or includes one or more of the selected safety-critical episodes.

7. A system for training a safety-critical autonomous agent, comprising at least one processor and computer-readable memory accessible by the at least one processor, the memory storing software comprising computer instructions that, when executed by the at least one processor, configures the at least one processor to:
obtain initial training data to be used for training a safety-critical autonomous agent;
densify the initial training data using a data densification process in order to generate densified training data, wherein the data densification process includes:
selecting safety-critical episodes from the initial training data in order to generate safety-critical episode training data; and/or
generating artificial safety-critical episode data representing one or more artificial safety-critical episodes, wherein the artificial safety-critical episode data is generated based on at least one safety-critical episode;
wherein the densified training data is or is based on one or both of the safety-critical episode training data and the artificial safety-critical episode data; and
train a safety-critical autonomous agent using the densified training data.

8. The method of claim 7, wherein the data densification process further includes: modifying one or more states of one or more safety-critical episodes in order to remove non-informative states.

9. The method of claim 8, wherein the data densification process includes selecting safety-critical episodes from the initial training data in order to generate the safety-critical episode training data, and wherein the one or more safety-critical episodes modified to remove the non-informative states includes at least one of the selected safety-critical episodes.

10. The method of claim 7, wherein the data densification process includes:
selecting the safety-critical episodes from the initial training data;
modifying one or more states of one or more of the selected safety-critical episodes in order to remove non-informative states; and
generating the artificial safety-critical episode data representing one or more artificial safety-critical episodes, wherein the artificial safety-critical episode data is generated based on at least one safety-critical episode.

11. The method of claim 10, wherein the artificial safety-critical episode data is generated as a result of a counterfactual simulation performed using output data of the safety-critical autonomous agent that was generated based on the at least one safety-critical episode.

12. The method of claim 11, wherein the at least one safety-critical episode is or includes one or more of the selected safety-critical episodes.

13. A method of training a safety-critical autonomous agent, wherein the method comprises:
obtaining initial training data that comprises data from both avoidable crash episodes and episodes where crashes were successfully avoided;
generating edited training data from the initial training data using Markov chain editing, wherein the edited training data has an increased proportion of safety-critical states than that contained in the initial training data;
providing an AV policy for use with the edited training data;
generating densified training data by reclassifying data for the AV policy through counterfactual simulation; and
training a safety-critical autonomous agent using the densified training data.

14. The method of claim 13, wherein generating edited training data further comprises obtaining a Markov chain of sampled driving episodes from the initial training data and editing the Markov chain sampled driving episodes so that only safety-critical states are retained and reconnected in the edited training data.

15. The method of claim 14, wherein editing the Markov chain sampled driving episodes comprises editing the Markov chain using a dense deep reinforcement learning densification process.
